(19) United States
(12) Patent Application Publication
(10) Pub. No.: US 2025/0145808 A1
(43) Pub. Date: May 8, 2025

(54) Thermoplastic Vulcanizates for Use at High Temperatures

(71) Applicant: Celanese International Corporation, Irving, TX (US)

(72) Inventors: Milind B. Joshi, Bengaluru (IN); Krishnan Anantha Narayana Iyer, Manvel, TX (US); Justin Crafton, Spring, TX (US); Eleni E. Stamatakis, Houston, TX (US)

(21) Appl. No.: 18/934,590

(22) Filed: Nov. 1, 2024

Related U.S. Application Data
(60) Provisional application No. 63/595,946, filed on Nov. 3, 2023.

(51) Int. Cl. C08L 19/00; C08L 69/00

(52) U.S. Cl. CPC C08L 19/00; C08L 69/005; C08L 2666/08; C08L 2666/18; C08L 2666/24

(57) ABSTRACT

A thermoplastic vulcanizate is disclosed. The thermoplastic vulcanizate comprises a thermoplastic copolyester elastomer in an amount of about 5 wt. % or more to about 50 wt. % or less based on the weight of the thermoplastic vulcanizate, an at least partially cured elastomer in an amount of about 5 wt. % or more to about 90 wt. % or less based on the weight of the thermoplastic vulcanizate, and a compatibilizer in an amount of from 1 wt. % or more to about 20 wt. % or less. The weight ratio of the at least partially cured elastomer to the thermoplastic copolyester elastomer is less than 1.25. The thermoplastic vulcanizate exhibits an elongation at break of 200% or more.

### CROSS-REFERENCE TO RELATED APPLICATION

This application claims the benefit of priority to U.S. Provisional Application No. 63/595,946 filed on Nov. 3, 2023, the contents of which are incorporated by reference herein in their entirety.

### BACKGROUND OF THE INVENTION

In general, thermoplastic vulcanizates can be formed by dynamically vulcanizing a formulation including a polymer and an elastomer. During the process, other additives may also be provided for various benefits and providing a resulting thermoplastic vulcanizate with certain desired properties. For example, various additives may be provided to obtain certain desired properties in a resulting thermoplastic vulcanizate, in particular when utilized at relatively high temperatures. This may allow the thermoplastic vulcanizate to be utilized at higher temperatures and/or lower temperatures for relatively longer periods of time. However, in certain applications, such additives may not necessarily be desired due to their chemical nature.

As such, a need currently exists for providing a thermoplastic vulcanizate having beneficial properties, particularly when utilized at high temperatures.

### SUMMARY OF THE INVENTION

In accordance with one embodiment of the present disclosure, a thermoplastic vulcanizate is disclosed. The thermoplastic vulcanizate comprises a thermoplastic copolyester elastomer in an amount of about 5 wt. % or more to about 50 wt. % or less based on the weight of the thermoplastic vulcanizate, an at least partially cured elastomer in an amount of about 5 wt. % or more to about 90 wt. % or less based on the weight of the thermoplastic vulcanizate, and a compatibilizer in an amount of from 1 wt. % or more to about 30 wt. % or less. The weight ratio of the at least partially cured elastomer to the thermoplastic copolyester elastomer is less than 1.25. The thermoplastic vulcanizate exhibits an elongation at break of 200% or more.

In accordance with another embodiment of the present disclosure, a method of making the aforementioned thermoplastic vulcanizate is disclosed. The method comprises dynamically vulcanizing a formulation comprising the thermoplastic copolyester elastomer, an elastomer, and a compatibilizer to provide the thermoplastic vulcanizate comprising the thermoplastic copolyester elastomer, the at least partially cured elastomer, and the compatibilizer.

Other features and aspects of the present disclosure are set forth in greater detail below.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to a thermoplastic copolyester elastomer-based thermoplastic vulcanizate. The present inventors have discovered that a thermoplastic vulcanizate as disclosed herein may exhibit desired properties, particularly at high temperatures. For instance, the thermoplastic vulcanizate may exhibit desired mechanical properties even when exposed to high temperatures.

In this regard, the thermoplastic vulcanizate may exhibit a particular Shore A hardness (ISO 868-85; 15 seconds), which is utilized to measure the hardness of the thermoplastic vulcanizate and provide an indication of the resistance to indentation. In this regard, the thermoplastic vulcanizate may have a Shore A hardness of from 25 to 100. For instance, the thermoplastic vulcanizate may have a Shore A hardness of 25 or more, such as 30 or more, such as 35 or more, such as 40 or more, such as 45 or more, such as 50 or more, such as 55 or more, such as 60 or more, such as 65 or more, such as 70 or more, such as 75 or more, such as 80 or more. The thermoplastic vulcanizate may have a Shore A hardness of 100 or less, such as 95 or less, such as 90 or less, such as 80 or less, such as 70 or less, such as 65 or less, such as 60 or less, such as 55 or less, such as 50 or less. Such hardness may allow for the thermoplastic vulcanizate to provide the compliance necessary to effectively function for a desired application. In one embodiment, the aforementioned Shore A hardness may be for an unaged sample. In another embodiment, the aforementioned Shore A hardness may be for an aged sample. For instance, the sample may be aged in an oven for 3 days at 125° C. or 3 days at 160° C. In this regard, such Shore A hardness may be realized at least at one or both of the aforementioned aging conditions.

In addition, the thermoplastic vulcanizate may exhibit a certain strength as indicated by certain mechanical properties. For instance, the thermoplastic vulcanizate may exhibit a 100% modulus (ASTM D412-16, Die C, across flow), also referred to as the modulus at 100% elongation, of at least 0.3 MPa, such as from 0.5 to 8 MPa, such as from 1 to 7 MPa. For instance, the 100% modulus may be 0.3 MPa or more, such as 0.4 MPa or more, such as 0.5 MPa or more, such as 0.8 MPa or more, such as 1 MPa or more, such as 1.1 MPa or more, such as 1.2 MPa or more, such as 1.3 MPa or more, such as 1.4 MPa or more, such as 1.5 MPa or more, such as 2 MPa or more, such as 2.5 MPa or more, such as 3 MPa or more, such as 3.5 MPa or more, such as 4 MPa or more, such as 5 MPa or more, such as 6 MPa or more, such as 10 MPa or more, such as 20 MPa or more, such as 30 MPa or more. The 100% modulus may be 50 MPa or less, such as 40 MPa or less, such as 30 MPa or less, such as 25 MPa or less, such as 20 MPa or less, such as 15 MPa or less, such as 10 MPa or less, such as 8 MPa or less, such as 7 MPa or less, such as 6 MPa or less, such as 5.5 MPa or less, such as 5 MPa or less, such as 4.5 MPa or less, such as 4 MPa or less, such as 3.8 MPa or less, such as 3.5 MPa or less, such as 3.3 MPa or less, such as 3 MPa or less, such as 2.8 MPa or less, such as 2.5 MPa or less, such as 2.3 MPa or less, such as 2 MPa or less, such as 1.9 MPa or less, such as 1.8 MPa or less, such as 1.5 MPa or less, such as 1.3 MPa or less, such as 1.1 MPa or less, such as 0.8 MPa or less. In one embodiment, the aforementioned 100% modulus may be for an unaged sample. In another embodiment, the aforementioned 100% modulus may be for an aged sample. For instance, the sample may be aged in an oven for 3 days at 125° C. or 3 days at 160° C. In this regard, such 100% modulus may be realized at least at one or both of the aforementioned aging conditions.

The thermoplastic vulcanizate may also exhibit a tensile strength (tensile stress at break) of from 0.5 to 50 MPa, such as from 1 to 20 MPa, such as from 2 to 10 MPa. For instance, the thermoplastic vulcanizate may exhibit a tensile strength of 0.5 MPa or more, such as 1 MPa or more, such as 1.5 MPa or more, such as 2 MPa or more, such as 2.5 MPa or more, such as 3 MPa or more, such as 3.5 MPa or more, such as 4 MPa or more, such as 5 MPa or more, such as 6 MPa or more, such as 7 MPa or more, such as 10 MPa or more, such as 15 MPa or more, such as 20 MPa or more, such as 30 MPa or more, such as 40 MPa or more, such as 50 MPa or more, such as 60 MPa or more, such as 70 MPa or more. The tensile strength may be 100 MPa or less, such as 80 MPa or less, such as 60 MPa or less, such as 50 MPa or less, such as 40 MPa or less, such as 30 MPa or less, such as 25 MPa or less, such as 20 MPa or less, such as 18 MPa or less, such as 15 MPa or less, such as 13 MPa or less, such as 12 MPa or less, such as 11 MPa or less, such as 10 MPa or less, such as 9 MPa or less, such as 8 MPa or less, such as 7 MPa or less, such as 6.5 MPa or less, such as 6 MPa or less, such as 5.5 MPa or less, such as 5 MPa or less, such as 4.5 MPa or less, such as 4 MPa or less, such as 3.5 MPa or less, such as 3 MPa or less, such as 2.5 MPa or less. The tensile stress may be determined in accordance with ASTM D412-16 at a temperature of 23° C. (Die C, across flow). In one embodiment, the aforementioned tensile strength may be for an unaged sample. In another embodiment, the aforementioned tensile strength may be for an aged sample. For instance, the sample may be aged in an oven for 3 days at 125° C. or 3 days at 160° C. In this regard, such tensile strength may be realized at least at one or both of the aforementioned aging conditions.

The thermoplastic vulcanizate may also exhibit a desired elongation at break. For instance, the elongation at break may be 100% or more, such as 200% or more, such as 250% or more, such as 300% or more, such as 350% or more, such as 400% or more, such as 450% or more, such as 500% or more, such as 550% or more, such as 600% or more, such as 650% or more, such as 700% or more, such as 750% or more, such as 900% or more. The elongation at break may be 1500% or less, such as 1300% or less, such as 1000% or less, such as 800% or less, such as 600% or less, such as 550% or less, such as 500% or less, such as 450% or less, such as 400% or less, such as 350% or less, such as 300% or less. The elongation at break may be determined in accordance with ASTM D412-16 at a temperature of 23° C. (Die C, across flow). In one embodiment, the aforementioned elongation at break may be for an unaged sample. In another embodiment, the aforementioned elongation at break may be for an aged sample. For instance, the sample may be aged in an oven for 3 days at 125° C. or 3 days at 160° C. In this regard, such elongation at break may be realized at least at one or both of the aforementioned aging conditions.

The thermoplastic vulcanizate may also be characterized by an advantageously low compression set. For instance, the compression set may be 85% or less, such as 80% or less, such as 70% or less, such as 65% or less, such as 60% or less, such as 55% or less, such as 50% or less, such as 45% or less, such as 40% or less, such as 35% or less, such as 30% or less, such as 25% or less, such as 20% or less, such as 15% or less. The compression set may be 5% or more, such as 8% or more, such as 10% or more, such as 13% or more, such as 15% or more, such as 18% or more, such as 20% or more, such as 25% or more, such as 30% or more, such as 35% or more, such as 40% or more, such as 50% or more, such as 60% or more, such as 70% or more. The compression set may be determined in accordance with ASTM D395B-18 (Type 1 Specimen, 50%, 22 hours). Such aforementioned compression set is based on a temperature of 70° C.

The thermoplastic vulcanizate may also be characterized by a weight gain, as determined according to ASTM D471 for 24 hours at 121° C. using IRM903 oil. Such weight percentage provides the percent by weight of oil swell as an implicit measure of the degree of curing or crosslinking of the elastomer. Generally, low or partial crosslinking of elastomer yields higher oil swell values, whereas highly crosslinked dispersed elastomer will have a lower oil swell. In this regard, the wt. gain may be 1% or more, such as 2% or more, such as 3% or more, such as 5% or more, such as 10% or more, such as 15% or more, such as 20% or more, such as 30% or more, such as 40% or more, such as 50% or more, such as 60% or more, such as 70% or more, such as 80% or more, such as 90% or more, such as 100% or more. The weight gain may be 150% or less, such as 130% or less, such as 110% or less, such as 100% or less, such as 90% or less, such as 80% or less, such as 70% or less, such as 60% or less, such as 50% or less, such as 40% or less, such as 30% or less, such as 25% or less, such as 20% or less, such as 15% or less, such as 10% or less, such as 5% or less.

Various embodiments of the present disclosure will now be described in more detail.

### I. Thermoplastic Vulcanizate

In general, the thermoplastic vulcanizate is formed from a thermoplastic copolyester elastomer and an at least partially cured elastomer. In this regard, the thermoplastic copolyester elastomer and the at least partially cured elastomer may be presented within a thermoplastic vulcanizate composition and an elastomer may be provided within a formulation as defined herein to provide the at least partially cured elastomer. The thermoplastic vulcanizate formulation or composition as defined herein may also include a compatibilizer as defined herein. In addition, such formulation or composition may also optionally include one or more additives as defined herein and/or generally known in the art.

### A. Thermoplastic Copolyester Elastomer

As indicated above, the thermoplastic vulcanizate contains a thermoplastic copolyester elastomer. The thermoplastic vulcanizate may contain one or more thermoplastic copolyester elastomers in one embodiment. In one embodiment, the thermoplastic vulcanizate may contain a mixture of thermoplastic copolyester elastomers. For instance, more than one thermoplastic copolyester elastomer, such as two or three thermoplastic copolyester elastomers, may be utilized in the thermoplastic vulcanizate.

In general, any thermoplastic copolyester elastomer suitable for use in the manufacture of a thermoplastic vulcanizate can be employed as the thermoplastic copolyester elastomer. The thermoplastic copolyester elastomer may be a thermoplastic copolyestercarbonate elastomer, a thermoplastic copolyetherester elastomer, thermoplastic copolyesterester elastomer or a mixture thereof. For instance, the thermoplastic copolyester elastomer may be a thermoplastic copolyestercarbonate elastomer, a thermoplastic copolyetherester elastomer, or a mixture thereof. In one embodiment, the thermoplastic copolyester elastomer may be a thermoplastic copolyetherester elastomer. In another embodiment, the thermoplastic copolyester elastomer may be a thermoplastic copolyestercarbonate elastomer. In a further embodiment, the thermoplastic copolyester elastomer may be a thermoplastic copolyesterester elastomer.

The thermoplastic copolyester elastomer may include (a) a hard segment (e.g., hard polyester segment) and (b) a soft segment (e.g., soft polyester segment). In one embodiment, such segments may be presented as blocks to provide a thermoplastic copolyester elastomer as a block copolymer. Examples of hard segments include, but are not limited to, polyalkylene terephthalates (e.g., polybutylene terephthalate, polybutylene terephthalate, etc.), poly(cyclohexanedicarboxylic acid cyclohexanemethanol), etc. and the like as well as mixtures thereof. In one particular embodiment, the hard segment may include a polyalkylene terephthalate. For instance, the polyalkylene terephthalate may include polybutylene terephthalate. Examples of soft segments include, but are not limited to, aliphatic polyesters including, but not limited to, polybutylene adipate, polytetramethyladipate, polycaprolactone, polytetramethylene oxide, etc. as well as aromatic polyesters including, but not limited to, polycarbonate as well as mixtures thereof. In one particular embodiment, the soft segment may include polytetramethylene oxide, polycarbonate, or a combination thereof. In one particular embodiment, the soft segment may include polytetramethylene oxide. In another particular embodiment, the soft segment may include a polycarbonate.

The thermoplastic copolyester elastomer in one embodiment may include a hard segment including polybutylene terephthalate and a soft segment including polycarbonate. In another embodiment, the thermoplastic copolyester elastomer may include a hard segment including polybutylene terephthalate and a soft segment including polytetramethylene oxide.

The thermoplastic copolyester elastomer, such as a copolyesterester elastomer, may contain one or more blocks of ester units of a high melting polyester and one or more blocks of ester units of a low melting polyester which are linked together through ester groups or urethane groups. Elastomers comprising urethane groups may be prepared by reacting the different polyesters in the molten phase, after which the resulting elastomer is reacted with a low molecular weight polyisocyanate. The polyisocyanate may be a diisocyanate or a triisocyanate. In particular, the polyisocyanate may be a diisocyanate, such as a paratoluene diisocyanate, diphenylmethane diisocyanate, xylylene diisocyanate, hexamethylene diisocyanate, and/or isophorone diisocyanate.

As indicated above, the thermoplastic copolyester elastomer, such as a copolyetherester elastomer, may have a multiplicity of recurring long-chain ester units and/or short-chain ester units. Such units may be joined head-to-tail through ester linkages. The long-chain ester units can be represented by formula (A):

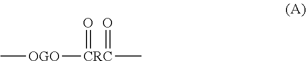

and the short-chain ester units can be represented by formula (B):

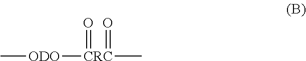

wherein
G is a divalent radical remaining after the removal of the terminal hydroxyl groups from a long chain polymeric glycol having a number average molecular weight of between about 400 and about 6000, preferably between about 400 and about 3000, even more preferably between about 600 and about 3000;
R is a divalent radical remaining after removal of carboxyl groups from a dicarboxylic acid having a number average molecular weight of less than about 300; and
D is a divalent radical remaining after removal of hydroxyl groups from a diol having a number average molecular weight of less than about 250.

As used herein, the term “long-chain ester units” refers to the reaction product of a long-chain glycol with a dicarboxylic acid. The long chain glycols are polymeric glycols having terminal (or nearly terminal as possible) hydroxyl groups. In particular, suitable long-chain glycols include poly(alkylene oxide) glycols having terminal (or as nearly terminal as possible) hydroxyl groups and having a number average molecular weight of from about 400 to about 6000, such as from about 400 to about 3000, such as from about 600 to about 3000, such as from about 1000 to about 3000, such as from about 1000 to about 2000. In addition, the long-chain glycols may have a melting point of less than about 65° C., such as less than about 60° C., such as less than about 55° C., such as less than about 50° C. The long chain glycols are generally poly(alkylene oxide) glycols or glycol esters of poly(alkylene oxide) dicarboxylic acids. Preferred poly(alkylene oxide) glycols include poly(tetramethylene oxide) glycol, poly(trimethylene oxide) glycol, poly(propylene oxide) glycol (e.g., 1,2- or 1,3-propylene oxide), poly(ethylene oxide) glycol, poly(hexamethylene oxide) glycol, poly(heptamethylene oxide) glycol, poly(octamethylene oxide) glycol, poly(nonamethylene oxide) glycol, and poly(1,2-butylene oxide) glycol, copolymer glycols of these alkylene oxides, and block copolymers such as ethylene oxide-capped poly(propylene oxide) glycol. In addition, it should be understood that a mixture of two or more of these glycols may also be utilized. Also, any substituent groups can be present which do not interfere with polymerization of the compound with glycol(s) or dicarboxylic acid(s), as the case may be. The hydroxyl functional groups of the long chain glycols which react to form the copolyester can be terminal groups to the extent possible. The terminal hydroxyl groups can be placed on end capping glycol units different from the chain (e.g., ethylene oxide end groups on poly(propylene oxide glycol). Long chain ester units of Formula (A) may also be referred to as “soft segments” of a copolyester elastomer.

As used herein, the term “short-chain ester units” refers to low molecular weight compounds or polymer chain units having a number average molecular weight of less than about 550, such as less than about 525, such as less than about 500, such as less than about 475, such as less than about 450. They can generally be made by reacting a low molecular weight diol or a mixture of diols (molecular weight below about 250, such as below about 225, such as below about 200, such as below about 175, such as below about 150) with a dicarboxylic acid to form ester units represented by Formula (B) above. Short chain ester units of Formula (B) may also be referred to as “hard segments” of a copolyester polymer.

Included among the low molecular weight diols which react to form short-chain ester units for preparing copolyesters are acyclic, alicyclic and aromatic dihydroxy compounds. These compounds include diols with about 2 to about 15 carbon atoms, such as about 2 to about 8 carbon atoms, such as about 2 to about 6 carbon atoms, such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, and the like. In particular, the diol may be an aliphatic diol, such as 1,4-butanediol, ethylene glycol, 1,3-propanediol, cyclohexanedimethanol, and/or hexamethylene glycol. For instance, the diol may be ethylene glycol, 1,4 butanediol, 1,3-propane diol, or a combination thereof. In particular, the diol may be 1,4 butanediol, 1,3-propane diol, or a combination thereof. In one embodiment, 1,4-butanediol is preferred. In another embodiment, ethylene glycol is preferred. In another further embodiment, 1,3-propanediol is preferred. In one embodiment, 1,4-butanediol may be provided as a mixture with ethylene glycol, 1,3-propanediol, cyclohexanedimethanol, and/or hexamethylene glycol. Included among the bisphenols which can be used are bis(p-hydroxy)diphenyl, bis(p-hydroxyphenyl)methane, and bis(p-hydroxyphenyl)propane. Equivalent ester-forming derivatives of diols are also useful (e.g., ethylene oxide or ethylene carbonate can be used in place of ethylene glycol or resorcinol diacetate can be used in place of resorcinol).

As used herein, the term “diols” includes equivalent ester-forming derivatives such as those mentioned. However, the molecular weight requirements refer to the corresponding diols and not their derivatives.

The dicarboxylic acids that can react with the aforementioned long-chain glycols and low molecular weight diols to produce the copolyesters may include aliphatic, cycloaliphatic or aromatic dicarboxylic acids of a low molecular weight (e.g., having a molecular weight of less than about 300, such as less than about 275, such as less than about 250, such as less than about 225). The term “dicarboxylic acids” as used herein includes functional equivalents of dicarboxylic acids that have two carboxyl functional groups that perform substantially like dicarboxylic acids in reaction with glycols and diols in forming thermoplastic copolyester elastomers. These equivalents include esters and ester-forming derivatives such as acid halides and anhydrides. The molecular weight requirement pertains to the acid and not to its equivalent ester or ester-forming derivative.

Thus, an ester of a dicarboxylic acid having a molecular weight greater than 300 or a functional equivalent of a dicarboxylic acid having a molecular weight greater than 300 are also suitable, provided the corresponding acid has a molecular weight below about 300 or the aforementioned molecular weights. The dicarboxylic acid can contain any substituent groups or combinations that do not substantially interfere with thermoplastic copolyester elastomer formation and use of the thermoplastic copolyester elastomer in the composition.

As used herein, the term “aliphatic dicarboxylic acids” refers to carboxylic acids having two carboxyl groups, each attached to a saturated carbon atom. If the carbon atom to which the carboxyl group is attached is saturated and is in a ring, the acid is cycloaliphatic. Aliphatic or cycloaliphatic acids having conjugated unsaturation often may not be used because of homopolymerization. However, some unsaturated acids, such as maleic acid, may be used.

As used herein, the term “aromatic dicarboxylic acids” refers to dicarboxylic acids having two carboxyl groups each attached to a carbon atom in a carbocyclic aromatic ring structure. It is not necessary that both functional carboxyl groups be attached to the same aromatic ring and where more than one ring is present, they can be joined by aliphatic or aromatic divalent radicals or divalent radicals such as —O— or —SO₂—.

Representative aliphatic and cycloaliphatic acids that can be used include, but are not limited to, sebacic acid; 1,3-cyclohexane dicarboxylic acid; 1,4-cyclohexane dicarboxylic acid; adipic acid; glutaric acid; succinic acid; 4-cyclohexane-1,2-dicarboxylic acid; 2-ethylsuberic acid; cyclopentanedicarboxylic acid, decahydro-1,5-naphthylene dicarboxylic acid; 4,4′-bicyclohexyl dicarboxylic acid; decahydro-2,6-naphthylene dicarboxylic acid; 4,4′-methylenebis (cyclohexyl) carboxylic acid; 3,4-furan dicarboxylic acid; and mixtures thereof. In one embodiment, the preferred acid may include a cyclohexane dicarboxylic acid and/or adipic acid.

Representative aromatic dicarboxylic acids that can be used include, but are not limited to, phthalic, terephthalic and isophthalic acids; bibenzoic acid; substituted dicarboxy compounds with two benzene nuclei such as bis(p-carboxyphenyl) methane; p-oxy-1,5-naphthalene dicarboxylic acid; 2,6-naphthalene dicarboxylic acid; 2,7-naphthalene dicarboxylic acid; 4,4′-sulfonyl dibenzoic acid and C₁-C₁₂ alkyl and ring substitution derivatives thereof, such as halo, alkoxy, and aryl derivatives; and mixtures thereof. Hydroxy acids such as p-(beta-hydroxyethoxy)benzoic acid can also be used, provided an aromatic dicarboxylic acid is also used.

In one embodiment, an aromatic dicarboxylic acid is preferred for preparing thermoplastic copolyester elastomers. Among the aromatic dicarboxylic acids, those with 8 to 16 carbon atoms, such as 8 to 12 carbon atoms, such as 8 to 10 carbon atoms may be preferred. In particular, the aromatic dicarboxylic acid may include terephthalic acid, phthalic acid, and/or isophthalic acid. In particular, the aromatic dicarboxylic acid may include terephthalic acid, isophthalic acid, or a combination thereof. In one embodiment, the aromatic acid may include terephthalic acid alone or with a mixture of phthalic acid and/or isophthalic acid.

When a mixture of two or more dicarboxylic acids is used to prepare the copolyester elastomer, isophthalic acid may be a preferred second dicarboxylic acid in one embodiment. For instance, isophthalic acid may be provided in a mixture with terephthalic acid. In this regard, the amount of copolymerized isophthalate residues in the copolyester elastomer may be less than 35 mole %, such as less than 30 mole %, such as less than 25 mole %. Similarly, copolymerized isophthalate residues in the copolyester elastomer may be less than 35 wt. %, such as less than 30 wt. %, such as less than 25 wt. %, based on the total weight of copolymerized dicarboxylic acid residues —(—C(O)RC(O)—)— in the copolyester elastomer. The remainder of the phenylene diradicals may be derived from terephthalic acid based on the total number of moles of copolymerized dicarboxylic acid residues —(—C(O)RC(O)—)— in the copolyester elastomer.

In addition, in one embodiment, at least about 70 mol. % of the groups represented by R in Formulae (A) and (B) above may be 1,4-phenylene radicals and at least about 70 mol. % of the groups represented by D in Formula (B) above may be 1,4-butylene radicals and the sum of the percentages of R groups which are not 1,4-phenylene radicals and D groups which are not 1,4-butylene radicals may not exceed 30 mol. %.

For example, thermoplastic copolyester elastomer may have hard segments composed of polybutylene terephthalate and about 5 wt. % to about 80 wt. %, such as about 5 wt. % to about 75 wt. %, such as about 10 wt. % to about 70 wt. %, such as about 10 wt. % to about 60 wt. %, such as about 20 wt. % to about 60 wt. %. The thermoplastic copolyester elastomer may have soft segments composed of the reaction product of a polyether glycol and an aromatic diacid. The polyether blocks may be derived from polytetramethylene glycol. Complementarily, the fraction of soft segments may be about 20 wt. % to about 95 wt. %, such as about 20 wt. % to about 90 wt. %, such as about 30 wt. % to about 90 wt. %, such as about 40 wt. % to about 90 wt. %, such as about 40 wt. % to about 80 wt. %.

While not limited, preferred thermoplastic copolyetherester elastomers include those prepared from monomers comprising the following: (A) (1) poly(tetramethylene oxide) glycol, (2) a dicarboxylic acid selected from isophthalic acid, terephthalic acid or a mixture thereof, and (3) a diol selected from 1,4-butanediol, 1,3-propanediol or a mixture thereof; (B) (1) poly(trimethylene oxide) glycol, (2) a dicarboxylic acid selected from isophthalic acid, terephthalic acid or a mixture thereof, and (3) a diol selected from 1,4-butanediol, 1,3-propanediol or a mixture thereof; or (C) (1) ethylene oxide-capped poly(propylene oxide) glycol; (2) a dicarboxylic acid selected from isophthalic acid, terephthalic acid or a mixture thereof; and (3) a diol selected from 1,4-butanediol, 1,3-propanediol or a mixture thereof.

Preferably, the thermoplastic copolyetherester elastomers may be prepared from esters or mixtures of esters of terephthalic acid or isophthalic acid, 1,4-butanediol and poly(tetramethylene ether)glycol, poly(trimethylene ether) glycol, or ethylene oxide-capped polypropylene oxide glycol or may be prepared from esters of terephthalic acid (e.g., dimethylterephthalate), 1,4-butanediol and poly(ethylene oxide)glycol). More preferably, the thermoplastic copolyetherester elastomers may be prepared from esters of terephthalic acid (e.g., dimethylterephthalate), 1,4-butanediol and poly(tetramethylene ether)glycol.

For instance, in one particular embodiment, the thermoplastic copolyetherester elastomer may have the following formula: -[4GT]ₓ-[BT]_{y}-, wherein 4G is the residue of butylene glycol, such as 1,4-butane diol, B is the residue of poly(tetramethylene ether glycol) and T is terephthalate, and wherein x is from about 0.60 to about 0.99 and y is from about 0.01 to about 0.40.

In one aspect, the thermoplastic copolyetherester elastomer can be a block copolymer of polybutylene terephthalate and polyether segments and can have a structure as follows:

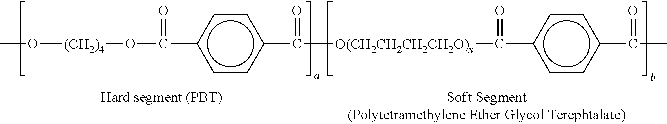

wherein a and b are integers and can vary from 2 to 10,000. The ratio between hard segments and soft segments in the block copolymer as described above can be varied in order to vary the properties of the elastomer.

In general, the thermoplastic copolyester elastomer preferably comprises about 1 wt. % or more, such as about 5 wt. % or more, such as about 10 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 55 wt. % or more of copolymerized residues of hard segments. The thermoplastic copolyester elastomer preferably comprises about 85 wt. % or less, such as about 80 wt. % or less, such as about 75 wt. % or less, such as about 70 wt. % or less, such as about 65 wt. % or less, such as about 60 wt. % or less of copolymerized residues of hard segments. For instance, these segments may refer to the long-chain ester units of Formula (A) above for the copolyetherester elastomer.

In general, the thermoplastic copolyester elastomer preferably comprises about 10 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more of copolymerized residues of soft segments. The thermoplastic copolyester elastomer preferably comprises about 99 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less of copolymerized residues of soft segments. For instance, these segments may refer to the soft-chain ester units of Formula (B) above for the copolyetherester elastomer.

In one embodiment, the thermoplastic copolyester elastomer may comprise only copolymerized residues of the hard segments and soft segments as mentioned above. In this regard, such hard segments and soft segments may be complementary. That is, the sum of the weight percentages of the copolymerized units of the hard segments and the soft segments may be 100 wt. %. Similarly, the mole percentages of such segments may also be complementary. That is, the sum of the mole percentages of the hard segments and soft segments may be 100 mol %.

In one embodiment, the thermoplastic copolyester elastomer may comprise only copolymerized residues of long-chain ester units corresponding to Formula (A) above and short-chain ester units corresponding to Formula (B) above. In this regard, the weight percentages of the copolymerized units of Formula (A) and Formula (B) in the copolyester may be complementary. That is, the sum of the weight percentages of the copolymerized units of Formula (A) and Formula (B) may be 100 wt. %. Similarly, the mole percentages of the R groups in the copolymerized units of Formula (A) and Formula (B) in the copolyester copolymer may be complementary. That is, the sum of the mole percentages of the R groups in the copolymerized units of Formula (A) and Formula (B) may be 100 mol %.

In one embodiment, as indicated herein, thermoplastic copolyester elastomer may be a thermoplastic copolyestercarbonate elastomer. In this regard, such elastomer may include carbonate bonds and ester bonds. The thermoplastic copolyestercarbonate elastomer may contain a repeating carbonate unit of formula (1)

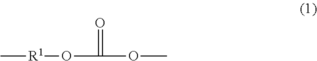

wherein
each R¹ in the carbonate units is a C₆₋₃₆ aromatic group.

In one embodiment, at least about 60 percent of the total number of R¹ groups contain aromatic organic groups and the balance thereof are aliphatic or alicyclic, or aromatic groups.

In general, R¹ can be derived from a dihydroxy compound of formula (2):

HO-A¹-Y¹-A²-OH (2)

wherein
each of A¹ and A² is a monocyclic divalent aromatic group and Y¹ is a single bond or a bridging group having one or more atoms that separate A¹ from A².

In one embodiment, one atom separates A¹ from A². Specifically, each R¹ can be derived from a dihydroxy aromatic compound of formula (3):

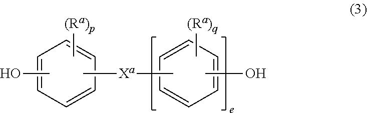

wherein
R^{a} and R^{b} each represent a halogen or C₁₋₁₂ alkyl group and can be the same or different;
e is 0 or 1; and
p and q are each independently integers of 0 to 4.

In general, it will be understood that R^{a} is hydrogen when p is 0, and R^{b} is hydrogen when q is 0. Also in formula (3), X^{a} represents a bridging group connecting the two hydroxy-substituted aromatic groups, where the bridging group and the hydroxy substituent of each C₆ arylene group are disposed ortho, meta, or para (specifically para) to each other on the C₆ arylene group. In an embodiment, the bridging group X^{a} is single bond, —O—, —S—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In one embodiment, R^{a} and R^{b} are each a C₁₋₃ alkyl group, specifically methyl, disposed meta to the hydroxy group on each arylene group.

In one embodiment, X^{a} is a C₁₋₁₈ alkylene group, a C₃₋₁₈ cycloalkylene group, a fused C₆₋₁₈ cycloalkylene group, or a group of the formula —B¹—W—B²— wherein B¹ and B² are the same or different C₁₋₆ alkylene groups and W is a C₃₋₁₂ cycloalkylidene group or a C₆₋₁₆ arylene group.

Specific examples of the types of bisphenol compounds represented by formula (3) include, but are not limited to, 1,1-bis(4-hydroxyphenyl)methane, 1,1-bis(4-hydroxyphenyl)ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxy-t-butylphenyl)propane, 3,3-bis(4-hydroxyphenyl)phthalimidine, 2-phenyl-3,3-bis(4-hydroxyphenyl)phthalimidine (“PBPP”), 9,9-bis(4-hydroxyphenyl)fluorene, and 1,1-bis(4-hydroxy-3-methylphenyl)cyclohexane (“DMBPC”). In one embodiment, the carbonate unites may be derived from bisphenol A. Combinations comprising at least one of the foregoing dihydroxy aromatic compounds can also be used.

As indicated herein, the thermal copolyestercarbonate copolymers also contain ester units (also referred to as linkages) in addition to the carbonate units described above. The ester units may contain repeating ester units of formula (4):

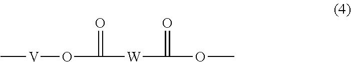

wherein
each V or W can be the same or different and is independently a divalent group derived from a dihydroxy compound or a chemical equivalent thereof, and W can be, for example, a C₆ to C₂₀ aliphatic group.

In an embodiment, V can be derived from a dihydroxy aromatic compound of formula (2), specifically bisphenol A, formula (3), or a combination comprising at least one of the foregoing dihydroxy aromatic compounds. Examples of diacids from which the T group in the ester unit of formula (4) may be derived include aliphatic and cycloaliphatic acids as well as aromatic dicarboxylic acids as mentioned above.

Related to formula (4), the thermoplastic copolyestercarbonate elastomer may include the short-chain ester units be represented by formula (B) above:

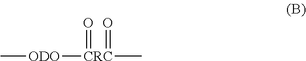

wherein D and R are as defined above. In addition, the aforementioned description with respect to such units may also apply herein with respect to the thermoplastic copolyestercarbonate elastomer.

Furthermore, regarding the thermoplastic copolyester elastomers, in particular a mixture of thermoplastic copolyester elastomers, each elastomer used need not on an individual basis come within the values set forth above for the elastomers. In this regard, the mixture of two or more thermoplastic copolyester elastomers may conform to the values described herein for the thermoplastic copolyester elastomers on a weighted average basis, however. For example, in a mixture that contains equal amounts of two thermoplastic copolyester elastomers, such as two thermoplastic copolyether ester elastomers, one can contain 60 weight percent short-chain ester units and the other resin can contain 30 weight percent short-chain ester units for a weighted average of 45 weight percent short-chain ester units.

Regarding the properties of the thermoplastic copolyester elastomer, it may be desired to have a melt flow that can allow it to be processed in a relatively easy manner for the formation of a molded part. In this regard, the thermoplastic copolyester elastomer may exhibit a relatively low melt viscosity as indicated by the melt flow rate. For instance, the melt flow rate of the thermoplastic copolyester elastomer may be about 0.5 g/10 min or more, such as about 1 g/10 min or more, such as about 2 g/10 min or more, such as about 3 g/10 min or more, such as about 4 g/10 min or more, such as about 5 g/10 min or more. The melt flow rate may be about 10 g/10 min or less, such as about 8 g/10 min or less, such as about 6 g/10 min or less, such as about 5 g/10 min or less, such as about 4 g/10 min or less, such as about 3 g/10 min or less. The melt flow rate may be determined at 220° C. under a 2.16 kg load according to ISO1133.

The thermoplastic copolyester elastomer may also have a relatively low melting temperature. For instance, the melting temperature may be about 100° C. or more, such as about 110° C. or more, such as about 130° C. or more, such as about 150° C. or more, such as about 170° C. or more, such as about 190° C. or more, such as about 200° C. or more, such as about 220° C. or more, such as about 240° C. or more. The melting temperature may be about 300° C. or less, such as about 280° C. or less, such as about 250° C. or less, such as about 230° C. or less, such as about 210° C. or less, such as about 200° C. or less, such as about 180° C. or less, such as about 160° C. or less, such as about 140° C. or less, such as about 120° C. or less. The melting temperature may be determined using means known in the art, such as differential scanning calorimetry in accordance with ISO 11357-1:2023 at a rate of 10° C./min.

In addition, the glass transition temperature of the thermoplastic copolyester elastomer, in particular the thermoplastic copolyester elastomer, may be within a particular range. For instance, the glass transition temperature may be about −80° C. or more, such as about −70° C. or more, such as about −60° C. or more, such as about −50° C. or more, such as about −40° C. or more, such as about −30° C. or more, such as about −20° C. or more, such as about −10° C. or more. The glass transition temperature may be about 10° C. or less, such as about 5° C. or less, such as about 0° C. or less, such as about −5° C. or less, such as about −10° C. or less, such as about −20° C. or less, such as about −30° C. or less, such as about −40° C. or less. Also, the glass transition temperature of the hard segment of the thermoplastic copolyester elastomer may be within a particular range. For instance, the glass transition temperature of the hard segment may be about 30° C. or more, such as about 35° C. or more, such as about 40° C. or more, such as about 45° C. or more, such as about 50° C. or more, such as about 55° C. or more, such as about 60° C. or more, such as about 65° C. or more, such as about 70° C. or more, such as about 75° C. or more, such as about 80° C. or more. The glass transition temperature may be about 150° C. or less, such as about 140° C. or less, such as about 130° C. or less, such as about 120° C. or less, such as about 110° C. or less, such as about 100° C. or less, such as about 90° C. or less, such as about 80° C. or less, such as about 70° C. or less, such as about 60° C. or less, such as about 55° C. or less, such as about 50° C. or less, such as about 45° C. or less, such as about 40° C. or less, such as about 35° C. or less, such as about 30° C. or less. The glass transition temperature may be determined using means known in the art, such as differential scanning calorimetry in accordance with ISO 11357-1:2023 at a rate of 10° C./min.

Further, the thermoplastic copolyester elastomer may have a particular density. For instance, the density be about 1 g/cm³ or more, such as about 1.03 g/cm³ or more, such as about 1.05 g/cm³ or more, such as about 1.08 g/cm³ or more, such as about 1.1 g/cm³ or more, such as about 1.15 g/cm³ or more, such as about 1.2 g/cm³ or more, such as about 1.3 g/cm³ or more. The thermoplastic copolyester elastomer may have a density of about 2 g/cm³ or less, such as about 1.8 g/cm³ or less, such as about 1.6 g/cm³ or less, such as about 1.4 g/cm³ or less, such as about 1.3 g/cm³ or less, such as about 1.25 g/cm³ or less, such as about 1.2 g/cm³ or less, such as about 1.18 g/cm³ or less, such as about 1.15 g/cm³ or less, such as about 1.12 g/cm³ or less, such as about 1.1 g/cm³ or less. The density may be determined in accordance with ISO 1183-1:2019.

In addition, the thermoplastic copolyester elastomer may not be as likely to resist deformation in bending compared to other types of materials and as a result, the thermoplastic copolyester elastomer may exhibit a relatively low flexural modulus. For instance, the flexural modulus may be about 300 MPa or less, such as about 260 MPa or less, such as about 220 MPa or less, such as about 200 MPa or less, such as about 190 MPa or less, such as about 180 MPa or less, such as about 170 MPa or less, such as about 160 MPa or less, such as about 150 MPa or less, such as about 140 MPa or less, such as about 130 MPa or less, such as about 120 MPa or less, such as about 110 MPa or less, such as about 100 MPa or less, such as about 90 MPa or less, such as about 80 MPa or less, such as about 70 MPa or less, such as about 60 MPa or less, such as about 50 MPa or less, such as about 40 MPa or less, such as about 30 MPa or less, such as about 20 MPa or less. The flexural modulus may be about 10 MPa or more, such as about 15 MPa or more, such as about 20 MPa or more, such as about 25 MPa or more, such as about 30 MPa or more, such as about 35 MPa or more, such as about 40 MPa or more, such as about 45 MPa or more, such as about 50 MPa or more, such as about 60 MPa or more, such as about 70 MPa or more, such as about 80 MPa or more, such as about 90 MPa or more, such as about 100 MPa or more, such as about 110 MPa or more, such as about 120 MPa or more, such as about 130 MPa or more, such as about 140 MPa or more, such as about 150 MPa or more, such as about 180 MPa or more, such as about 200 MPa or more. The flexural modulus may be determined in accordance with ISO 178:2019 at a temperature of about 23° C.

Relatedly, the thermoplastic copolyester elastomer may have a particular Shore D hardness, which can provide an indication of the resistance to indentation of the thermoplastic copolyester elastomer. In this regard, the Shore D hardness may be about 15 or more, such as about 20 or more, such as about 25 or more, such as about 30 or more, such as about 35 or more, such as about 40 or more, such as about 45 or more, such as about 50 or more. The Shore D hardness may be about 60 or less, such as about 55 or less, such as about 50 or less, such as about 45 or less, such as about 40 or less, such as about 35 or less, such as about 30 or less. Such hardness may allow for the thermoplastic copolyester elastomer to provide the compliance necessary to effectively function for a desired application. The Shore D hardness may be determined in accordance with ISO 868-2003 (15 seconds).

In addition, the thermoplastic copolyester elastomer may have other beneficial mechanical properties. For instance, the tensile stress at break may be about 60 MPa or less, such as 50 MPa or less, such as 45 MPa or less, such as about 40 MPa or less, such as about 35 MPa or less, such as about 30 MPa or less, such as about 30 MPa or less, such as about 25 MPa or less. The tensile stress at break may be about 5 MPa or more, such as about 10 MPa or more, such as about 15 MPa or more, such as about 20 MPa or more, such as about 25 MPa or more, such as about 30 MPa or more, such as about 35 MPa or more. The tensile stress at break may be determined in accordance with ISO 527-1/-2 (2012) at a temperature of about 23° C.

Also, the thermoplastic copolyester elastomer may have a relatively high nominal strain at break. For instance, the nominal strain at break may be about 250% or more, such as about 300% or more, such as about 350% or more, such as about 400% or more, such as about 450% or more, such as about 500% or more, such as about 550% or more, such as about 600% or more, such as about 650% or more, such as about 700% or more, such as about 750% or more, such as about 800% or more, such as about 850% or more. The nominal strain at break may be about 2000% or less, such as about 1800% or less, such as about 1600% or less, such as about 1400% or less, such as about 1200% or less, such as about 1100% or less, such as about 1000% or less, such as about 950% or less, such as about 900% or less, such as about 850% or less, such as about 800% or less, such as about 700% or less, such as about 600% or less, such as about 500% or less. The nominal strain at break may be determined in accordance with ISO 527-1/-2 (2012) at a temperature of about 23° C.

The thermoplastic vulcanizate may generally comprise about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more of the thermoplastic copolyester elastomer. The thermoplastic vulcanizate may comprise about 50 wt. % or less, such as about 45 wt. % or less, such as about 40 wt. % or less, such as about 35 wt. % or less, such as about 30 wt. % or less, such as about 25 wt. % or less, such as about 20 wt. % or less, such as about 15 wt. % or less of the thermoplastic copolyester elastomer. In another embodiment, such aforementioned weight percentages may be based on the combined weight of the thermoplastic copolyester elastomer and the elastomer combined within the thermoplastic vulcanizate.

### B. Elastomer

As indicated above, the thermoplastic vulcanizate contains an elastomer, in particular an at least partially cured elastomer. In general, any elastomer suitable for use in the manufacture of TPVs can be utilized in accordance with the present disclosure. In one embodiment, one elastomer may be utilized as the elastomer. In other embodiments, the elastomer may include a mixture of elastomers. For instance, more than one elastomer, such as two or three elastomers, may be utilized in the thermoplastic vulcanizate.

Any elastomer or mixture thereof that is capable of being vulcanized (that is crosslinked or cured) can be used as the elastomer (also referred to herein sometimes as the rubber). Reference to a rubber or elastomer may include mixtures of more than one. Useful elastomers typically contain a degree of unsaturation in their polymeric main chain. Some non-limiting examples of these rubbers include polyolefin copolymer elastomers, butyl rubber, natural rubber, styrene-butadiene copolymer rubber (e.g., styrene/ethylene-butadiene/styrene), butadiene rubber, acrylonitrile rubber, halogenated rubber such as brominated and chlorinated isobutylene-isoprene copolymer rubber, butadiene-styrene-vinyl pyridine rubber, urethane rubber, polyisoprene rubber, epichlolorohydrin terpolymer rubber, and polychloroprene.

Vulcanizable elastomers includes polyolefin copolymer elastomers. These copolymers are made from one or more of ethylene and higher alpha-olefins, which may include, but are not limited to propylene, 1-butene, 1-hexene, 4-methyl-1 pentene, 1-octene, 1-decene, or combinations thereof, and may include one or more copolymerizable, multiply unsaturated comonomer, such as diolefins, or diene monomers. The alpha-olefins can be propylene, 1-hexene, 1-octene, or combinations thereof. These rubbers may lack substantial crystallinity and can be suitably amorphous copolymers.

The diene monomers may include, but are not limited to, 5-ethylidene-2-norbornene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; dicyclopentadiene; 5-vinyl-2-norbornene, divinyl benzene, and the like, or a combination thereof. The diene monomers can be 5-ethylidene-2-norbornene and/or 5-vinyl-2-norbornene. If the copolymer is prepared from ethylene, alpha-olefin, and diene monomers, the copolymer may be referred to as a terpolymer (EPDM rubber), or a tetrapolymer in the event that multiple alpha-olefins or dienes, or both, are used (EAODM rubber).

In one embodiment, the polyolefin elastomer copolymer may include an ethylene acrylic copolymer (also referred to as an ethylene-acrylate copolymer). The ethylene acrylic copolymer comprises (i) copolymerized units of a monomer having the structure represented by formula (A):

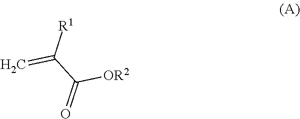

wherein R¹ is hydrogen or a C₁-C₁₂ alkyl and R² is a C₁-C₁₂ alkyl, a C₁-C₂₀ alkoxyalkyl, a C₁-C₁₂ cyanoalkyl, or a C₁-C₁₂ haloalkyl (e.g., fluoroalkyl or bromoalkyl) and (ii) copolymerized units of ethylene. The ethylene acrylic copolymer may also optionally comprise (iii) copolymerized units of an unsaturated carboxylic acid or an anhydride thereof.

The ethylene acrylic copolymer may be amorphous. The term “amorphous” generally refers to a copolymer that exhibits little or no crystalline structure at room temperature in the unstressed state. Alternatively, an amorphous material may have a heat of fusion of less than 4 J/g, as determined according to ASTM D3418-08.

As indicated above, the ethylene acrylic copolymer comprises copolymerized units (i) of the monomer of formula (A). Such monomer may be an alkyl ester or alkoxyalkyl ester of propenoic acid. In this regard, the ethylene acrylic copolymer may comprise an alkyl ester or alkoxyalkyl ester of propenoic acid together with a cure site monomer and an ethylene monomer. Examples of suitable alkyl and alkoxyalkyl esters of propenoic acid include alkyl acrylates and alkoxyalkyl acrylates as well as monomers in which the propenoic acid is substituted with a C₁-C₁₂ alkyl group. Examples include an alkyl methacrylate, an alkyl ethacrylate, an alkyl propacrylate, an alkyl hexacrylate, an alkoxyalkyl methacrylate, an alkoxyalkyl ethacryate, an alkoxyalkyl propacrylate, an alkoxyalkyl hexacrylate, and any combination thereof.

The alkyl and alkoxyalkyl esters of propenoic acid and substituted propenoic acids can be C₁-C₁₂ alkyl esters of acrylic or methacrylic acid or C₁-C₂₀ alkoxyalkyl esters of acrylic or methacrylic acid. Examples include methyl acrylate, methyl methacrylate, ethyl acrylate, ethyl methacrylate, butyl acrylate, butyl methacrylate, 2-ethylhexyl acrylate, 2 methoxyethylacrylate, 2-ethoxyethylacrylate, 2-(n-propoxy)ethylacrylate, 2 (n-butoxy)ethylacrylate, 3-methoxypropylacrylate, 3-ethoxypropyl-acrylate, and mixtures thereof. The ester group can comprise branched or unbranched C₁-C₈ alkyl groups or unbranched C₁-C₄ alkyl groups. Specific examples include alkyl (meth)acrylate esters such as methyl acrylate, methyl methacrylate, ethyl acrylate, butyl acrylate, and mixtures thereof.

The polymerized units of the monomer of formula (A) can be present in an amount ranging from about 20% or more, such as about 30% or more, such as about 40% or more, such as about 45% or more, such as about 50% or more, to about 75% or less, such as about 70% or less, such as about 65% or less by weight of the ethylene acrylic copolymer. For example, polymerized units of the monomer of formula (A), such as a propenoic acid ester comonomer, can be present in an amount ranging from about 45% or from about 50% to about 70% by weight of the ethylene acrylic copolymer. In some examples, the concentration of polymerized units of the monomer of formula (A), such as a propenoic acid ester comonomer, can range from about 55% to about 70% by weight of the ethylene acrylic copolymer. Also, as generally understood, the polymerized units of the monomer of formula (A) may include a first monomer of formula (A) and a second monomer of (A) wherein the combination of the monomers is present in the aforementioned weight percentages.

In addition to comprising the polymerized units of a monomer of formula (A), the ethylene acrylic copolymer comprises copolymerized units of ethylene. The copolymerized units of ethylene can constitute the remainder of the weight % of the ethylene acrylic copolymer, after accounting for the copolymerized units of the monomer of formula (A) and any other monomers, such as the optional copolymerized units of the unsaturated carboxylic acid or an anhydride thereof. For example, the copolymerized units of ethylene can be present in an amount ranging from about 10% or more, such as about 15% or more, such as about 20% or more, such as about 25% or more, such as about 28% or more, such as about 30% or more, such as about 35% or more, such as about 40% or more to about 65% or less, such as about 60% or less, such as about 58% or less, such as about 55% or less, such as about 50% or less, such as about 45% or less, such as about 40% or less by weight of the ethylene acrylic copolymer. The copolymerized units of ethylene can constitute the balance of the weight percent being attributed to the copolymerized units of the monomer of formula (A) and if present, the copolymerized units of the unsaturated carboxylic acid or an anhydride thereof.

In addition to comprising the polymerized units of a monomer of formula (A) and the copolymerized units of ethylene, the ethylene acrylic copolymer may further comprise a copolymerized cure site monomer such as a carboxylic acid, an anhydride thereof, or any mixture of the acid and anhydride of the acid. Suitable unsaturated carboxylic acids include acrylic acid, methacrylic acid, 1,4-butenedioic acids, citraconic acid, monoalkyl esters of 1,4-butenedioic acids, and mixtures thereof. The 1,4-butenedioic acids may exist in cis- or trans-form or both (e.g., maleic acid or fumaric acid) prior to polymerization. Suitable cure site comonomers also include anhydrides of unsaturated carboxylic acids, such as maleic anhydride, citraconic anhydride, itaconic anhydride, and mixtures thereof. Cure site monomers can include maleic acid and any of its half acid esters (monoesters) or diesters, such as the methyl or ethyl half acid esters (e.g., monoethyl maleate); fumaric acid and any of its half acid esters or diesters, such as the methyl, ethyl or butyl half acid esters; and monoalkyl and monoarylalkyl esters of itaconic acid. The cure site monomer can be present in some examples in an amount ranging from about 0.5% or more, such as about 1% or more, such as about 1.5% or more, such as about 2% or more to about 10% or less, such as about 8% or less, such as about 6% or less, such as about 5% or less, such as about 4% or less, such as about 3% or less by weight of the ethylene acrylic copolymer, such as from about 2% to about 5% by weight, such as from about 2% to about 4% by weight of the ethylene acrylic copolymer.

The ethylene acrylic copolymer may consist essentially of or consist of the copolymerized units of the monomer of formula (A), the copolymerized units of ethylene, and the optional copolymerized units of an unsaturated carboxylic acid or an anhydride thereof. In another embodiment, the ethylene acrylic copolymer may consist essentially of or consist of the copolymerized units of the monomer of formula (A), the copolymerized units of ethylene, and the copolymerized units of an unsaturated carboxylic acid or an anhydride thereof. “Consist essentially of” in this context refers an ethylene acrylic copolymer that does not materially diminish the elastomeric properties of the ethylene acrylic copolymer if the copolymer consisted solely of the copolymerized units.

One specific example of the ethylene acrylic copolymer includes a copolymer of (i) methyl acrylate, butyl acrylate, or any combination thereof, present in an amount ranging from about 50% to about 70% by weight of the ethylene acrylic copolymer; (ii) ethylene, which constitutes the remainder of the weight % of the ethylene acrylic copolymer; and (iii) a cure site monomer having carboxylic acid functionality, present in an amount ranging from about 2% to about 5% by weight of the ethylene acrylic copolymer (e.g., 2% to 4%).

Elastomers that are polyolefin elastomer copolymers can contain, unless specified otherwise herein, from about 15 to about 90 mole percent ethylene units deriving from ethylene monomer, from about 40 to about 85 mole percent, or from about 50 to about 80 mole percent ethylene units. The copolymer may contain from about 10 to about 85 mole percent, or from about 15 to about 50 mole percent, or from about 20 to about 40 mole percent, alpha-olefin units deriving from alpha-olefin monomers. The foregoing mole percentages are based upon the total moles of the mer units of the polymer. Where the copolymer contains diene units, the copolymers may contain from 0.1 to about 14 weight percent, from about 0.2 to about 13 weight percent, or from about 1 to about 12 weight percent units deriving from diene monomer. The weight percent diene units deriving from diene may be determined according to ASTM D-6047. In some occurrences, the copolymers contain less than 5.5 weight percent, such as less than 5.0 weight percent, such as less than 4.5 weight percent, such as less than 4.0 weight percent units deriving from diene monomer. In yet other cases, the copolymers contain greater than 6.0 weight percent, such as greater than 6.2 weight percent, such as greater than 6.5 weight percent, such as greater than 7.0 weight percent units, such as greater than 8.0 weight percent deriving from diene monomer.

The polyolefin elastomer copolymer may be obtained using polymerization techniques known in the art such as traditional solution or slurry polymerization processes. For instance, the catalyst employed to polymerize the ethylene, alpha-olefin, and diene monomers into elastomeric copolymers can include both traditional Ziegler-Natta type catalyst systems, especially those including titanium and vanadium compounds, as well as metallocene catalysts for Group 3-6 (titanium, zirconium and hafnium) metallocene catalysts, particularly the bridged mono- or biscyclopentadienyl metallocene catalysts. Other catalyst systems such as Brookhart catalyst systems may also be employed.

In one embodiment, the elastomer may include a butyl rubber. For instance, the butyl rubber includes copolymers and terpolymers of isobutylene and at least one other comonomer. Useful comonomers include isoprene, divinyl aromatic monomers, alkyl substituted vinyl aromatic monomers, and mixtures thereof. Exemplary divinyl aromatic monomers include vinyl styrene. Exemplary alkyl substituted vinyl aromatic monomers include α-methyl styrene and paramethyl styrene. These copolymers and terpolymers may also be halogenated such as in the case of chlorinated and brominated butyl rubber. In one or more embodiments, these halogenated polymers may derive from monomers such as parabromomethylstyrene.

In one or more embodiments, the butyl rubber includes copolymers of isobutylene and isoprene, copolymers of isobutylene and paramethyl styrene, terpolymers of isobutylene, isoprene, and divinyl styrene, branched butyl rubber, and brominated copolymers of isobutene and paramethylstyrene (yielding copolymers with parabromomethylstyrenyl mer units). These copolymers and terpolymers may be halogenated. Furthermore, butyl rubbers may be prepared by polymerization, using techniques known in the art such as at a low temperature in the presence of a Friedel-Crafts catalyst.

In one embodiment, where the butyl rubber includes the isobutylene-isoprene copolymer, the copolymer may include from about 0.5 to about 30, or from about 0.8 to about 5, percent by weight isoprene based on the entire weight of the copolymer with the remainder being isobutylene.

In another embodiment, where the butyl rubber includes isobutylene-paramethyl styrene copolymer, the copolymer may include from about 0.5 to about 25, and from about 2 to about 20, percent by weight paramethyl styrene based on the entire weight of the copolymer with the remainder being isobutylene. In one embodiment, isobutylene-paramethyl styrene copolymers can be halogenated, such as with bromine, and these halogenated copolymers can contain from about 0 to about 10 percent by weight, or from about 0.3 to about 7 percent by weight halogenation.

In other embodiments, where the butyl rubber includes isobutylene-isoprene-divinyl styrene, the terpolymer may include from about 95 to about 99, or from about 96 to about 98.5, percent by weight isobutylene, and from about 0.5 to about 5, or from about 0.8 to about 2.5, percent by weight isoprene based on the entire weight of the terpolymer, with the balance being divinyl styrene.

In the case of halogenated butyl rubbers, the butyl rubber may include from about 0.1 to about 10, or from about 0.3 to about 7, or from about 0.5 to about 3 percent by weight halogen based upon the entire weight of the copolymer or terpolymer.

In one or more embodiments, the glass transition temperature (Tg) of the butyl rubber can be less than about −55° C., or less than about −58° C., or less than about −60° C., or less than about −63° C. Also, the Mooney viscosity (ML₁₊₈@125° C.) of the butyl rubber can be from about 25 to about 75, or from about 30 to about 60, or from about 40 to about 55.

In general, the elastomer, in particular the polyolefin elastomer copolymer, may have a Mw of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more. The Mw may be about 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less. Furthermore, the elastomer, in particular the polyolefin elastomer copolymer, may have a Mn of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more. The Mn may be about 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less. In general, the molecular weight may be characterized by GPC (gel permeation chromatography) using polystyrene standards.

The thermoplastic vulcanizate can generally comprise about 2 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 40 wt. % or more, such as about 50 wt. % or more, such as about 60 wt. % or more, such as about 70 wt. % or more, such as about 80 wt. % or more of the elastomer. The thermoplastic vulcanizate may comprise about 90 wt. % or less, such as about 80 wt. % or less, such as about 70 wt. % or less, such as about 60 wt. % or less, such as about 50 wt. % or less, such as about 40 wt. % or less, such as about 35 wt. % or less, such as about 30 wt. % or less, such as about 25 wt. % or less, such as about 20 wt. % or less, such as about 15 wt. % or less of the elastomer. In another embodiment, such aforementioned weight percentages may be based on the combined weight of the thermoplastic copolyester elastomer and the elastomer combined in the thermoplastic vulcanizate. In another embodiment, such aforementioned weight percentages may be based on the combined weight of the thermoplastic copolyester elastomer, the elastomer, and the compatibilizer combined in the thermoplastic vulcanizate.

Furthermore, when a mixture of elastomers is present, the primary elastomer may be present in an amount of about 60 wt. % or more, such as about 70 wt. % or more, such as about 80 wt. % or more, such as about 90 wt. % or more to less than 100 wt. % based on the weight of the elastomer. The secondary elastomer may be present in an amount of 40 wt. % or less, such as 30 wt. % or less, such as 20 wt. % or less, such as 15 wt. % or less, such as 10 wt. % or less, such as 5 wt. % or more to more than 0 wt. % of the elastomer.

In addition, the thermoplastic copolyester elastomer and the aforementioned elastomer, such as the at least partially cured elastomer, may be provided in a particular weight ratio. For instance, the weight ratio of the aforementioned elastomer, such as the at least partially cured elastomer, to the thermoplastic copolyester elastomer is less than 1.25, such as 1.2 or less, such as 1.1 or less, such as 1 or less, such as 0.9 or less, such as 0.8 or less, such as 0.7 or less, such as 0.6 or less, such as 0.5 or less, such as 0.4 or less, such as 0.3 or less, such as 0.2 or less. The weight ratio may be 0.1 or more, such as 0.2 or more, such as 0.3 or more, such as 0.4 or more, such as 0.5 or more, such as 0.6 or more, such as 0.7 or more, such as 0.8 or more, such as 0.9 or more, such as 1 or more, such as 1.1 or more.

### C. Compatibilizer

As indicated above, the thermoplastic vulcanizate contains a compatibilizer. In general, any compatibilizer suitable for use in TPVs can be utilized in accordance with the present disclosure. In one embodiment, one compatibilizer may be utilized as the compatibilizer. In other embodiments, the compatibilizer may include a mixture of compatibilizers. For instance, more than one compatibilizer, such as two or three compatibilizers, may be utilized in the thermoplastic vulcanizate.

In general, the compatibilizer may include a functionalized polyolefin having one or more functional groups. Suitable functional groups may include, but are not limited to, a carboxyl group (or an ester thereof), a carbonyl group, a halogen atom, an amino group, a hydroxy group, an anhydride group, an epoxy group, or an oxazoline group. In one embodiment, the functional group may include a carboxyl group or an ester thereof. For instance, the compatibilizer may include, or be grafted with, α,β-ethylenically unsaturated mono- and/or dicarboxylic acids or derivatives thereof. In one embodiment, the functional group may include an epoxy group. For instance, the functional group may be a glycidyl ester of a carboxylic acid. In one embodiment, the functional group may include an anhydride, such as maleic anhydride. Such functional groups may extend from a side rather than a terminal end in one embodiment.

In general, in one embodiment, the compatibilizer, or the functionalized polyolefin, may include an olefin copolymer. In this regard, the copolymer may contain an olefinic monomeric unit that is derived from one or more α-olefins. Examples of such monomers include, for instance, linear and/or branched α-olefins having from 2 to 20 carbon atoms. For instance, the monomers may have 2 or more, such as 3 or more, such as 4 or more carbon atoms. The monomers may have 20 or less, such as 16 or less, such as 12 or less, such as 10 or less, such as 8 or less, such as 6 or less, such as 4 or less, such as 3 or less, such as 2 carbon atoms. Specific examples include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. It should be understood that any of the aforementioned monomers may be utilized in combination. Particularly desired α-olefin monomers are ethylene and propylene. In this regard, in one embodiment, the monomer may include ethylene thereby providing an ethylene copolymer. In another embodiment, the monomer may include propylene thereby providing a propylene copolymer. In a further embodiment, the monomers may include a combination of ethylene and propylene.

The olefin copolymer may be “epoxy-functionalized.” In this regard, the copolymer may also include an epoxy-functional monomeric unit. These may include, but are not limited to, aliphatic glycidyl ester monomers, aliphatic glycidyl ether monomers, alicyclic glycidyl ester monomers, alicyclic glycidyl ether monomers, etc. as well as mixtures thereof.

One example of such a unit is an epoxy-functional (meth)acrylic monomeric component. In some embodiments, such monomer may be referred to as a glycidyl ester of a carboxylic acid, in particular a glycidyl ester of an α,β-ethylenically unsaturated acid. As used herein, the term “(meth)acrylic” includes acrylic and methacrylic monomers, as well as salts or esters thereof, such as acrylate and methacrylate monomers. For example, suitable epoxy-functional (meth)acrylic monomers may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate. Other suitable monomers may also be employed to help achieve the desired molecular weight. It should be understood that any of the aforementioned monomers may be utilized in combination. In one embodiment, the epoxy-functional monomer may include glycidyl acrylate thereby providing an ethylene-glycidyl acrylate copolymer. In another embodiment, the monomer may include glycidyl methacrylate thereby providing an ethylene-glycidyl methacrylate copolymer.

Of course, the copolymer may also contain other monomeric units (e.g., non-epoxy functional monomeric units) as known in the art. For example, another suitable monomer may include a (meth)acrylic monomeric unit that is not epoxy-functional. Examples of such (meth)acrylic monomers may include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. In one embodiment, the other monomeric unit may include methyl acrylate. In another embodiment, the other monomer may include a butyl acrylate, such as n-butyl acrylate, s-butyl acrylate, i-butyl acrylate, or t-butyl acrylate. It should be understood that any of the aforementioned monomers may be utilized in combination.

Further, another suitable monomer may include a vinyl monomer. The vinyl monomer may be a styrene, a vinyl acetate, an acrylonitrile, etc. In one embodiment, the vinyl monomer may be a styrene. In another embodiment, the vinyl monomer may be a vinyl acetate. In a further embodiment, the vinyl monomer may be an acrylonitrile. It should be understood that any of the aforementioned monomers may be utilized in combination.

In one particular embodiment, for example, the copolymer may be a terpolymer formed from an α-olefin monomeric component, an epoxy-functional (meth)acrylic monomeric component, and a non-epoxy functional monomeric component, such as a non-epoxy functional (meth)acrylic monomeric component or a vinyl monomeric component. The copolymer may, for instance, be poly(ethylene-co-methyl acrylate-co-glycidyl methacrylate).

In this regard, examples of the compatibilizer may include, but are not limited to, ethylene/glycidyl methacrylate polymers, ethylene/glycidyl acrylate copolymers, ethylene/C₁₋₁₀ alkyl acrylate/glycidyl methacrylate copolymers (e.g., ethylene/methyl acrylate/glycidyl methacrylate copolymers, ethylene/ethyl acrylate/glycidyl methacrylate copolymers, etc.), ethylene/C₁₋₁₀ alkyl acrylate/glycidyl acrylate copolymers (e.g., ethylene/methyl acrylate/glycidyl acrylate copolymers, ethylene/ethyl acrylate/glycidyl acrylate copolymers, etc.), ethylene/C₁₋₁₀ alkyl methacrylate/glycidyl methacrylate copolymers (e.g., ethylene/methyl methacrylate/glycidyl methacrylate copolymers, ethylene/ethyl methacrylate/glycidyl methacrylate copolymers, etc.), ethylene/C₁₋₁₀ alkyl methacrylate/glycidyl acrylate copolymers (e.g., ethylene/methyl methacrylate/glycidyl acrylate copolymers, ethylene/ethyl methacrylate/glycidyl acrylate copolymers, etc.), ethylene/vinyl acetate/glycidyl methacrylate copolymers, and ethylene/vinyl acetate/glycidyl acrylate copolymers, etc. as well as mixtures thereof. In one embodiment, the compatibilizer may include an ethylene/glycidyl methacrylate copolymer. In one embodiment, the compatibilizer may include an ethylene/methyl acrylate/glycidyl methacrylate copolymer.

In one embodiment, the compatibilizer may be a graft copolymer. In this regard, one or more blocks of polymer may be grafted onto the main chain of the copolymer. In particular, the copolymer main chain on which the graft is provided may be any copolymer mentioned above. In this regard, the graft copolymer may have an olefin copolymer as a base onto which the graft is provided. For instance, it may be any copolymer made from an α-olefin monomer and an epoxy-functional monomer, such as an epoxy-functional (meth)acrylic monomer, as mentioned above. In addition, the copolymer may also optionally include a further non-epoxy functional monomer, such as a non-epoxy functional (meth)acrylic monomer, as mentioned above.

The graft is not necessarily limited by the present disclosure. The graft may be at least one vinyl polymer or one ether polymer. In one embodiment, the graft may be at least one vinyl polymer. In general, it should be understood that that the aforementioned polymer may also include copolymers.

In general, the graft polymer may include an ethylenically unsaturated monomer. In certain instances, such monomer may have a polar group. In general, the graft may include a vinyl polymer. In this regard, the graft polymer may include, but is not limited to, polyacrylonitrile, polystyrene, styrene/acrylonitrile copolymer, polymethyl methacrylate, ethylene-glycidyl methacrylate copolymer, etc. In one embodiment, the graft polymer may include, but is not limited to, polyacrylonitrile, polystyrene, styrene/acrylonitrile copolymer, or polymethyl methacrylate. In another embodiment, the graft polymer may include, but is not limited to, polyacrylonitrile, polystyrene, or styrene/acrylonitrile copolymer. For instance, the graft polymer may include polyacrylonitrile in one embodiment. In another embodiment, the graft polymer may include polystyrene. In a further embodiment, the graft polymer may include a styrene/acrylonitrile copolymer. In another embodiment, the graft polymer may include polymethyl methacrylate.

Specific examples of the compatibilizer including a graft polymer may include, but are not limited to, ethylene/glycidyl methacrylate copolymer-polymethyl methacrylate graft polymer, ethylene/glycidyl methacrylate copolymer-acrylonitrile/styrene copolymer graft polymer, ethylene/glycidyl methacrylate copolymer-polystyrene graft polymer, ethylene/ethyl acrylate copolymer-polymethyl methacrylate graft polymer, ethylene/ethyl acrylate copolymer-polyacrylonitrile graft polymer, ethylene/ethyl acrylate copolymer-polystyrene graft polymer, ethylene/vinyl acetate copolymer-polymethyl methacrylate graft polymer, ethylene/vinyl acetate copolymer-polyacrylonitrile graft polymer, ethylene/vinyl acetate copolymer-polystyrene graft polymer, polypropylene-polyacrylonitrile graft polymer, polypropylene-polystyrene graft polymer, polypropylene-polystyrene graft polymer, polyethylene-polymethyl methacrylate graft polymer, polyethylene-polyacrylonitrile graft polymer, polyethylene-polystyrene graft polymer, epoxy-modified polystyrene-polymethyl methacrylate graft polymer, polybutylene terephthalate-polystyrene graft polymer, acid-modified acrylate-polymethyl methacrylate graft polymers, acid-modified acrylate-polystyrene graft polymers, polystyrene-polymethyl methacrylate graft polymer, polystyrene-polyethylene graft polymer, polystyrene-polybutadiene graft polymer, polystyrene-polyacrylonitrile block copolymer, polystyrene-polybutyl acrylate block copolymer, etc. as well as mixtures thereof.

The relative portion of the monomeric component(s) may be selected to achieve desired properties. For instance, the α-olefin monomer(s) may constitute 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more of the copolymer. The α-olefin monomer(s) may constitute less than 100 wt. %, such as 98 wt. % or less, such as 95 wt. % or less, such as 90 wt. % or less, such as 85 wt. % or less, such as 80 wt. % or less, such as 75 wt. % or less, such as 70 wt. % or less, such as 65 wt. % or less of the copolymer. The epoxy-functional (meth)acrylic monomer(s) may constitute 1 wt. % or more, such as 2 wt. % or more, such as 3 wt. % or more, such as 4 wt. % or more, such as 5 wt. % or more, such as 6 wt. % or more, such as 7 wt. % or more, such as 8 wt. % or more, such as 9 wt. % or more, such as 10 wt. % or more, such as 15 wt. % or more, such as 20 wt. % or more of the copolymer. The epoxy-functional (meth)acrylic monomer(s) may constitute 40 wt. % or less, such as 30 wt. % or less, such as 25 wt. % or less, such as 20 wt. % or less, such as 18 wt. % or less, such as 16 wt. % or less, such as 14 wt. % or less, such as 12 wt. % or less, such as 10 wt. % or less, such as 8 wt. % or less, such as 6 wt. % or less of the copolymer. When employed, other monomeric components (e.g., non-epoxy functional (meth)acrylic monomers) may constitute 1 wt. % or more, such as 2 wt. % or more, such as 3 wt. % or more, such as 4 wt. % or more, such as 5 wt. % or more, such as 6 wt. % or more, such as 7 wt. % or more, such as 8 wt. % or more, such as 9 wt. % or more, such as 10 wt. % or more, such as 12 wt. % or more, such as 14 wt. % or more, such as 16 wt. % or more, such as 18 wt. % or more, such as 20 wt. % or more, such as 25 wt. % or more of the copolymer. When employed, other monomeric components (e.g., non-epoxy functional (meth)acrylic monomers) may constitute less than 50 wt. %, such as 45 wt. % or less, such as 40 wt. % or less, such as 35 wt. % or less, such as 30 wt. % or less, such as 25 wt. % or less, such as 20 wt. % or less, such as 15 wt. % or less of the copolymer.

The melt flow rate of the compatibilizer may be from about 1 to about 30 grams per 10 minutes (“g/10 min”), in some embodiments from about 2 to about 20 g/10 min, and in some embodiments, from about 3 to about 15 g/10 min, as determined in accordance with ASTM D1238-13 at a load of 2.16 kg and temperature of 190° C.

In addition, the compatibilizer may be a block copolymer in one embodiment. In another embodiment, the compatibilizer may be a random copolymer. Further, the compatibilizer may be a graft copolymer. In this regard, in one embodiment, the compatibilizer may be a block and graft copolymer. In another embodiment, the compatibilizer may be a random and graft copolymer.

The thermoplastic vulcanizate can generally comprise about 0.5 wt. % or more, such as about 1 wt. % or more, such as about 2 wt. % or more, such as about 3 wt. % or more, such as about 4 wt. % or more, such as about 5 wt. % or more, such as about 6 wt. % or more, such as about 8 wt. % or more, such as about 10 wt. % or more, such as about 12 wt. % or more, such as about 15 wt. % or more of the compatibilizer. The thermoplastic vulcanizate may comprise about 30 wt. % or less, such as about 25 wt. % or less, such as about 20 wt. % or less, such as about 15 wt. % or less, such as about 12 wt. % or less, such as about 10 wt. % or less, such as about 8 wt. % or less, such as about 6 wt. % or less of the compatibilizer. In another embodiment, such aforementioned weight percentages may be based on the combined weight of the thermoplastic copolyester elastomer, the elastomer, and the compatibilizer combined in the thermoplastic vulcanizate.

### D. Curing Composition

As indicated herein, the TPV formulation, in particular the elastomer within the formulation, may undergo dynamic vulcanization wherein the elastomer is at least partially cured. In general, any curing agent that is capable of curing or crosslinking the elastomer may be used. Some non-limiting examples of these curing agents include phenolic resins, peroxides, maleimides, and silicon-containing curing agents. The curing agents may be used with one or more coagents that serve as initiators, catalysts, etc. for purposes of improving the overall cure state of the elastomer. For instance, the curing composition of some embodiments includes one or both of zinc oxide (ZnO) and stannous chloride (SnCl₂).

In general, the phenolic resins may not necessarily be limited. For instance, these may include resole resins made by the condensation of alkyl substituted phenols or unsubstituted phenols with aldehydes, which can be formaldehydes, in an alkaline medium or by condensation of bi-functional phenoldialcohols. The alkyl substituents of the alkyl substituted phenols typically contain 1 to about 10 carbon atoms. Dimethylol phenols or phenolic resins, substituted in para-positions with alkyl groups containing 1 to about 10 carbon atoms can be used. These phenolic curing agents may be thermosetting resins and may be referred to as phenolic resin curing agents or phenolic resins. These phenolic resins may be ideally used in conjunction with a catalyst system. For example, non-halogenated phenol curing resins are used in conjunction with halogen donors and, optionally, a hydrogen halide scavenger. Where the phenolic curing resin is halogenated, a halogen donor is not required but the use of a hydrogen halide scavenger, such as ZnO, can be used.

Peroxide curing agents are generally selected from organic peroxides. Examples of organic peroxides include, but are not limited to, di-tert-butyl peroxide, dicumyl peroxide, t-butylcumyl peroxide, alpha, alpha-bis(tert-butylperoxy)diisopropyl benzene, 2,5 dimethyl 2,5-di(t-butylperoxy)hexane, 1,1-di(t-butylperoxy)-3,3,5-trimethyl cyclohexane, benzoyl peroxide, lauroyl peroxide, dilauroyl peroxide, 2,5-dimethyl-2,5-di(tert-butylperoxy)hexyne-3, and mixtures thereof. Also, diaryl peroxides, ketone peroxides, peroxydicarbonates, peroxyesters, dialkyl peroxides, hydroperoxides, peroxyketals and mixtures thereof may be used.

The silicon-containing curing agents generally include silicon hydride compounds having at least two SiH groups. These compounds react with carbon-carbon double bonds of unsaturated polymers in the presence of a hydrosilylation catalyst. Silicon hydride compounds include, but are not limited to, methylhydrogen polysiloxanes, methylhydrogen dimethyl-siloxane copolymers, alkyl methyl polysiloxanes, bis(dimethylsilyl)alkanes, bis(dimethylsilyl)benzene, and mixtures thereof.

As noted above, hydrosilylation curing may be conducted in the presence of a catalyst. These catalysts can include, but are not limited to, peroxide catalysts and catalysts including transition metals of Group VIII. These metals include, but are not limited to, palladium, rhodium, and platinum, as well as complexes of these metals.

In certain embodiments, the curing composition also includes one or both of ZnO and SnCl₂. In one embodiment, the curing composition may include zinc oxide. In another embodiment, the curing composition may include stannous chloride. In a further embodiment, the curing composition may include zinc oxide and stannous chloride.

Coagents may also be employed with the curing agents, such as the phenolic resin and/or peroxides. The coagent may include a multi-functional acrylate ester, a multi-functional methacrylate ester, or combination thereof. In other words, the coagents include two or more organic acrylate or methacrylate substituents. Examples of multi-functional acrylates include diethylene glycol diacrylate, trimethylolpropane triacrylate (TMPTA), ethoxylated trimethylolpropane triacrylate, propoxylated trimethylolpropane triacrylate, propoxylated glycerol triacrylate, pentaerythritol triacrylate, bistrimethylolpropane tetraacrylate, pentaerythritol tetraacrylate, ethoxylated pentaerythritol tetraacrylate, ethoxylated pentaerythritol triacrylate, cyclohexane dimethanol diacrylate, ditrimethylolpropane tetraacrylate, or combinations thereof. Examples of multi-functional methacrylates include trimethylol propane trimethacrylate (TMPTMA), ethylene glycol dimethacrylate, butanediol dimethacrylate, butylene glycol dimethacrylate, diethylene glycol dimethacrylate, polyethylene glycol dimethacrylate, allyl methacrylate, or combinations thereof. The coagent may also include triallylcyanurate, triallyl isocyanurate, triallyl phosphate, sulfur, N-phenyl-bis-maleamide, zinc diacrylate, zinc dimethacrylate, divinyl benzene, 1,2-polybutadiene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, oximer for e.g., quinone dioxime, and the like.

Furthermore, an oil can be employed in the cure system. The oil may also be referred to as a process oil, an extender oil, or plasticizer. Useful oils include mineral oils, synthetic processing oils, or combinations thereof and may act as plasticizers. The plasticizers include, but are not limited to, aromatic, naphthenic, and extender oils. Exemplary synthetic processing oils include low molecular weight polylinear alpha-olefins, and polybranched alpha-olefins. Suitable esters include monomeric and oligomeric materials having an average molecular weight below about 2,000 g/mole, or below about 600 g/mole. Specific examples include aliphatic mono- or diesters or alternatively oligomeric aliphatic esters or alkyl ether esters.

The curing composition may be added in one or more locations, including the feed hopper of a melt mixing extruder. In some embodiments, the curing agent and any additional coagents may be added to the TPV formulation together; in other embodiments, one or more coagents may be added to the TPV formulation at different times from any one or more of the curing agents, as the TPV formulation is undergoing processing to form a TPV.

In general, the amount of curing agent present should be sufficient to at least partially vulcanize the elastomer and in some embodiments, to completely vulcanize the elastomer.

### E. Other Additives

The thermoplastic vulcanizates and formulations of some embodiments may optionally further comprise one or more additives. Suitable additional TPV additives include, but are not limited to, fillers, reinforcing agents, process oils, process aids, plasticizers, stabilizers (e.g., heat stabilizers; UV light stabilizers; metal deactivators; antioxidants such as phenolic, phosphite, and/or amine containing antioxidants; acid scavengers; etc.), viscosity modifiers, nucleating agents, lubricants, waxes, flow enhancing additives, flame retardants (e.g., phosphates such as polyphosphates, pyrophosphates, etc.; phosphinates; etc.), impact modifiers, antiblocking agents, antistatic agents, antimicrobial agents, foaming agents, colorants, pigments, etc. In this regard, the resulting thermoplastic vulcanizate may also comprise one or more of such additives.

Any suitable process oil may be included in some embodiments. In particular embodiments, process oils may be selected from: (i) extension oil, that is, oil present in an oil-extended rubber (such as oil present with the elastomer); (ii) free oil, that is, oil that is added during the vulcanization process (separately from any other TPV formulation component such as the elastomer and thermoplastic vulcanizate); (iii) curative oil, that is, oil that is used to dissolve/disperse the curing agents, for example, a curative-in-oil dispersion such as a phenolic resin-in-oil (and in such embodiments, the curing composition may therefore be present in the TPV formulation as the curative-in-oil additive); and (iv) any combination of the foregoing oils from (i)-(iii). Thus, process oil may be present in a TPV formulation as part of another component (e.g., as part of the elastomer when the process oil is an extension oil, such that the elastomer comprises elastomer and extension oil; or as part of the curing composition when the process oil is the carrier of a curative-in-oil, such that the curing composition comprises the curative oil and a curing agent). On the other hand, process oil may be added to the TPV separately from other components, i.e., as free oil.

The extension oil, free oil, and/or curative oil may be the same or different oils in various embodiments. Process oils may include one or more of (i) “refined” or “mineral” oils, and (ii) synthetic oils. As used herein, mineral oils refer to any hydrocarbon liquid of lubricating viscosity (i.e., a kinematic viscosity at 100° C. of 1 mm²/sec or more) derived from petroleum crude oil and subjected to one or more refining and/or hydroprocessing steps (such as fractionation, hydrocracking, dewaxing, isomerization, and hydrofinishing) to purify and chemically modify the components to achieve a final set of properties. Such “refined” oils are in contrast to “synthetic” oils, which are manufactured by combining monomer units into larger molecules using catalysts, initiators, and/or heat.

In general, either refined or synthetic process oils according to some embodiments may include, but are not limited to, any one or more of aromatic, naphthenic, and paraffinic oils. Exemplary synthetic processing oils are polylinear alpha-olefins, polybranched alpha-olefins, and hydrogenated polyalphaolefins. The compositions of some embodiments of this invention may include organic esters, alkyl ethers, or combinations thereof.

In certain embodiments, at least a portion of the process oil (e.g., all or a portion of any one or more of extension oil, free oil, and/or curative oil) is a low aromatic/sulfur content oil and has (i) an aromatic content of less than 5 wt. %, or less than 3.5 wt. %, or less than 1.5 wt. %, based on the weight of that portion of the process oil; and (ii) a sulfur content of less than 0.3 wt. %, or less than 0.003 wt. %, based on the weight of that portion of the process oil. Aromatic content may be determined in a manner consistent with method ASTM D2007. The percentage of aromatic carbon in the process oil of some embodiments is preferably less than 2, 1, or 0.5%. In certain embodiments, there are no aromatic carbons in the process oil. The proportion of aromatic carbon (%) as used herein is the proportion (percentage) of the number of aromatic carbon atoms to the number of all carbon atoms determined by the method in accordance with ASTM D2140.

Suitable process oils of particular embodiments may include API Group I, II, III, IV, and V base oils. See API 1509, Engine Oil Licensing and Certification System, 17th Ed., September 2012, Appx. E, incorporated herein by reference.

A TPV and/or formulation of some embodiments may also or instead include a polymeric processing additive. The processing additive employed in such embodiments is a polymeric resin that has a very high melt flow index. These polymeric resins include both linear and branched molecules that have a melt flow rate that is greater than about 500 dg/min, more preferably greater than about 750 dg/min, even more preferably greater than about 1000 dg/min, still more preferably greater than about 1200 dg/min, and still more preferably greater than about 1500 dg/min. The thermoplastic elastomers of the present disclosure may include mixtures of various branched or various linear polymeric processing additives, as well as mixtures of both linear and branched polymeric processing additives. Reference to polymeric processing additives will include both linear and branched additives unless otherwise specified. The preferred linear polymeric processing additives are polypropylene homopolymers. The preferred branched polymeric processing additives include diene-modified polypropylene polymers.

In addition, the formulation may also include reinforcing and/or non-reinforcing fillers. Fillers and extenders that can be utilized include conventional inorganics such as calcium carbonate, clays, silica, talc, titanium dioxide, as well as organic, such as carbon block, graphene, and organic and inorganic nanoscopic fillers. In one embodiment, the filler may include graphene. The graphene may be a monolayer or a multilayer (i.e., graphite). For instance, the graphene may be multilayer, such as bilayer graphene, trilayer graphene, or a mixture thereof. The graphene may be pristine graphene or CVD graphene. The graphene may also include graphene nanoplatelets, such as those having a thickness of from 1 nm to 3 nm and/or a lateral dimension of from 100 nm to 100 μm. Furthermore, the graphene may be modified. For instance, the graphene may be oxidized (graphene oxide), reduced graphene oxide, or functionalized graphene oxide. The aforementioned denominations are further defined per ISO/TS 8004-13:2017. In addition, the manner in which the graphene may be provided is also not limited. For instance, the graphene may be added in a powder form, pre-compacted, and/or via master-batch.

In certain embodiments, the TPV and/or formulation may include acid scavengers. These acid scavengers may be added to the thermoplastic vulcanizate after the desired level of cure has been achieved. Preferably, the acid scavengers are added after dynamic vulcanization. Useful acid scavengers include hydrotalcites. Both synthetic and natural hydrotalcites can be used. An exemplary natural hydrotalcite can be represented by the formula Mg₆Al₂(OH)₁₆CO₃·4H₂O. Synthetic hydrotalcite compounds may have formula Mg_{4.3}Al₂(OH)₁₂·6CO₃·mH₂O or Mg_{4.5}Al₂(OH)₁₃CO₃·3.5H₂O.

In certain embodiments, the TPV and/or formulation may include one or more antioxidants. For instance, the antioxidant may be a phenolic, a phosphite, and/or an amine containing antioxidant. In one embodiment, the antioxidant may be a phenolic antioxidant. In another embodiment, the antioxidant may be a phosphite antioxidant. In a further embodiment, the antioxidant may be an amine antioxidant.

These additives can be utilized in an amount to provide the desired effect. In this regard, the additives may be present in an amount of up to about 50 weight percent of the total TPV formulation or TPV. In this regard, a respective additive and/or combination of additives may be present in an amount of 0.001 wt. % or more, such as 0.01 wt. % or more, such as 0.05 wt. % or more, such as 0.1 wt. % or more, such as 0.2 wt. % or more, such as 0.3 wt. % or more, such as 0.5 wt. % or more, such as 1 wt. % or more, such as 2 wt. % or more, such as 3 wt. % or more, such as 5 wt. % or more, such as 8 wt. % or more, such as 10 wt. % or more, such as 12 wt. % or more, such as 15 wt. % or more, such as 20 wt. % or more, such as 25 wt. % or more, such as 30 wt. % or more. They may be present in an amount of 50 wt. % or less, such as 40 wt. % or less, such as 30 wt. % or less, such as 25 wt. % or less, such as 20 wt. % or less, such as 18 wt. % or less, such as 15 wt. % or less, such as 13 wt. % or less, such as 10 wt. % or less, such as 8 wt. % or less, such as 6 wt. % or less, such as 4 wt. % or less, such as 3 wt. % or less, such as 2 wt. % or less, such as 1 wt. % or less, such as 0.5 wt. % or less. In another embodiment, such aforementioned percentages may be based on the weight of the thermoplastic copolyester elastomer. In a further embodiment, such aforementioned percentages may be based on the weight of the elastomer. In an even further embodiment, such aforementioned percentages may be based on the combined weight of the thermoplastic copolyester elastomer and elastomer.

### F. TPV Formulation

In general, as used herein, a “TPV formulation” refers to the mixture of ingredients blended or otherwise compiled before or during processing of the TPV formulation in order to form a TPV. This is in recognition of the fact that the ingredients that are mixed together and then processed may or may not be present in the final TPV in the same amounts added to the formulation, depending upon the reactions that take place among some or all of the ingredients during processing of the mixed ingredients.

In general, a TPV formulation according to various embodiments includes the thermoplastic copolyester elastomer, elastomer, compatibilizer, and curing agent (or curing composition) along with any other optional additives. As will be discussed in more detail below, the TPV formulation undergoes processing, including dynamic vulcanization, to form a TPV. In certain embodiments, any other additives may be added to the TPV formulation during processing, either before or after dynamic vulcanization.

Relative amounts of the various components in TPV formulations are conveniently characterized based upon the amount of elastomer in the formulation, in particular in parts by weight per hundred parts by weight of rubber (phr). In embodiments wherein the elastomer comprises both elastomer with an extension oil, as is common for much commercially available elastomers such as EPDM, the phr amounts are based only upon the amount of elastomer, exclusive of extension oil present with the elastomer. Thus, as an example, an elastomer containing 100 parts EPDM (rubber) and 75 parts extension oil would in fact be considered present in a TPV formulation at 175 phr (i.e., on the basis of the 100 parts EPDM rubber). If such a TPV formulation were further characterized as containing 50 phr thermoplastic copolyester elastomer, the formulation would include 50 parts by weight of thermoplastic copolyester elastomer in addition to the 100 parts by weight elastomer and 75 parts by weight extension oil.

TPV formulations of some embodiments may include the thermoplastic copolyester elastomer in an amount from about 20 to about 300 parts per hundred parts by weight of the elastomer or rubber (phr). In various embodiments, the thermoplastic copolyester elastomer is included in a TPV formulation in an amount ranging from a low of any one of about 20, 25, 30, 35, 40, 45, 50, 55, 60, 65, 70, 75, 80, 85, 90, 95, 100, 105, 110, 115, 120, 125, 130, 135, 140, 145, 150, 165, 170, and 175 phr, to a high of any one of about 100, 125, 150, 175, 200, 225, 250, 275, and 300 phr. The thermoplastic copolyester elastomer may be included in an amount ranging from any of the aforementioned lows to any of the aforementioned highs, provided that the high value is greater than or equal to the low value. In particular embodiments, increasing amounts of thermoplastic copolyester elastomer correspond to increasing hardness of the dynamically vulcanized TPV.

When the elastomer consists of elastomer only, it is by definition present at 100 phr (since it is the basis of the phr notation). However, in embodiments wherein the elastomer component comprises a constituent other than an elastomer, such as an extender oil, the elastomer may be included in a TPV formulation in an amount ranging from a low of any one of about 100.05, 100.1, 100.15, 100.2, 105, 110, 115, and 120 phr to a high of any one of about 110, 120, 125, 150, 175, 200, 225, and 250 phr.

The compatibilizer is included in a TPV formulation in an amount ranging from a low of any one of about 1, 2, 3, 4, 5, 10, 15, 25, 30, 35, 40, 50 phr to a high of any one of about 5, 10, 15, 20, 25, 30, 35, 40, 45, 50, 55, 60, 65, 70, 75 phr. The compatibilizer may be included in an amount ranging from any of the aforementioned lows to any of the aforementioned highs, provided that the high value is greater than or equal to the low value.

As previously noted, TPV formulations of certain embodiments may optionally include additional TPV additives. Amounts of additional additive are separate and in addition to those additives already included in another component of a TPV formulation. For instance, any additive such as extension oil included with the elastomer has already been accounted for as part of the amount of elastomer added to the formulation; recited amounts of additional additives therefore are exclusive of additives already included with the elastomer. Additional additives may be present in a TPV formulation in the aggregate in an amount ranging from about 0 phr to about 300 phr. In certain embodiments, additional additives may in the aggregate be present in the TPV in an amount ranging from a low of any one of about 0, 5, 10, 15, 25, 30, 40, 50, 60, 70, 80, 90, and 100 phr, to a high of any one of about 25, 30, 40, 50, 60, 80, 100, 125, 150, 175, 200, 225, 250, 275, and 300 phr. The additional additives may be included in an aggregate amount ranging from any one of the aforementioned lows to any one of the aforementioned highs, provided that the high value is greater than or equal to the low value. In one embodiment, such aforementioned phr may refer to the additional additives individually rather than the aggregate.

For convenience, components of TPV formulations of various embodiments may alternatively be characterized based upon their weight percentages in the TPV formulation according to the following:

The thermoplastic copolyester elastomer(s) may be present in a TPV formulation in amounts ranging from a low of any one of about 5, 6, 7, 8, 9, 10, 11, 12, 13, 14, 15, 16, 17, 18, 19, 20, 21, 22, 23, 24, and 25 wt. % to a high of any one of about 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, and 50 wt. %, provided that the high is greater than or equal to the low.

The elastomer(s) may be present in a TPV formulation in amounts ranging from a low of any one of about 5, 6, 7, 8, 9, 10, 11, 12, 13, 14, 15, 16, 17, 18, 19, 20, 25, 30, and 35 wt. % to a high of any one of about 35, 40, 45, 50, 55, 60, 65, 70, 75, 80, 85, and 90 wt. %, provided that the high is greater than or equal to the low.

The compatibilizer(s) may be present in a TPV formulation in amounts ranging from a low of any one of about 1, 2, 3, 4, 5, 6, 7, 8, 9, 10, 11, 12, 13, 14, 15, 16, 17, 18, 19, and 20 wt. % to a high of any one of about 10, 11, 12, 13, 14, 15, 16, 17, 18, 20, 22, 24, 26, 28, and 30 wt. %, provided that the high is greater than or equal to the low.

The optional additional TPV additive(s) may be present in a TPV formulation in aggregate amounts ranging from a low of any one of about 0, 5, 10, 15, 20, 25, 30, 35, and 40 wt. % to a high of any one of about 30, 35, 40, 45, 50, 55, 60, and 65 wt. %, provided that the high is greater than or equal to the low.

### G. Processing TPV Formulations

The thermoplastic vulcanizate of the present disclosure is prepared by dynamic vulcanization techniques. The term “dynamic vulcanization” refers to a vulcanization or curing process for a TPV formulation comprising an elastomer, wherein the elastomer is vulcanized under conditions of high shear mixing at a temperature above the melting point of the thermoplastic copolyester elastomer to produce a thermoplastic vulcanizate. In dynamic vulcanization, the elastomer is simultaneously crosslinked and dispersed as fine particles within the thermoplastic copolyester elastomer or matrix, although other morphologies, such as co-continuous morphologies, may exist depending on the degree of cure, the elastomer to resin viscosity ratio, the intensity of mixing, the residence time, and the temperature.

In some embodiments, processing may include melt blending, in a chamber, a TPV formulation comprising the elastomer, thermoplastic copolyester elastomer, compatibilizer, and curing agent. The chamber may be any vessel that is suitable for blending the selected composition under temperature and shearing force conditions necessary to form a thermoplastic vulcanizate. In this respect, the chamber may be a mixer, such as Banbury™ mixers or Brabender™ mixers, and certain mixing extruders such as co-rotating, counter-rotating, and twin-screw extruders, as well as co-kneaders, such as Buss® kneaders. According to one embodiment, the chamber is an extruder, which may be a single or multi-screw extruder. The term “multi-screw extruder” means an extruder having two or more screws; with two and three screw extruders being exemplary, and two or twin screw extruders being preferred in some embodiments. The screws of the extruder may have a plurality of lobes; two and three lobe screws being preferred. It will readily be understood that other screw designs may be selected in accordance with the methods of embodiments of the present disclosure. In some embodiments, dynamic vulcanization may occur during and/or as a result of extrusion. After discharging from the mixer, the blend containing the vulcanized rubber and the thermoplastic can be milled, chopped, extruded, pelletized, injection-molded, or processed by any other desirable technique.

The dynamic vulcanization of the elastomer may be carried out to achieve relatively high shear. In particular embodiments, the blending may be performed at a temperature not exceeding about 400° C., preferably not exceeding about 300° C., and more preferably not exceeding about 250° C. The minimum temperature at which the melt blending is performed is generally higher than or equal to about 130° C., preferably higher than or equal to about 150° C. and more particularly higher than about 180° C. The blending time is chosen by taking into account the nature of the compounds used in the TPV formulation and the blending temperature. The time generally varies from about 5 seconds to about 120 minutes, and in most cases from about 10 seconds to about 30 minutes.

Dynamic vulcanization in some embodiments may include phase inversion. As those skilled in the art appreciate, dynamic vulcanization may begin by including a greater volume fraction of rubber than thermoplastic copolyester elastomer. As such, the thermoplastic copolyester elastomer may be present as the discontinuous phase when the rubber volume fraction is greater than that of the volume fraction of the thermoplastic copolyester elastomer. As dynamic vulcanization proceeds, the viscosity of the rubber increases and phase inversion occurs under dynamic mixing. In other words, upon phase inversion, the thermoplastic copolyester elastomer phase becomes the continuous phase.

Other additive(s) are preferably present within the TPV formulation when dynamic vulcanization is carried out, although in some embodiments, one or more other additives (if any) may be added to the composition after the curing and/or phase inversion (e.g., after the dynamic vulcanization portion of processing). The additional additives may be included after dynamic vulcanization by employing a variety of techniques. In one embodiment, they can be added while the thermoplastic vulcanizate remains in its molten state from the dynamic vulcanization process. For example, the additional additives can be added downstream of the location of dynamic vulcanization within a process that employs continuous processing equipment, such as a single or twin screw extruder. In other embodiments, the thermoplastic vulcanizate can be “worked-up” or pelletized, subsequently melted, and the additional additives can be added to the molten thermoplastic vulcanizate product. This latter process may be referred to as a “second pass” addition of the ingredients.

Despite the fact that the elastomer may be partially or fully cured, the thermoplastic vulcanizate can be processed and reprocessed by conventional plastic processing techniques such as extrusion, injection molding, and compression molding. The elastomer within these thermoplastic elastomers is usually in the form of finely-divided and well-dispersed particles of vulcanized or cured rubber within a continuous thermoplastic phase or matrix, although a co-continuous morphology or a phase inversion is also possible. In those embodiments where the cured rubber is in the form of finely-divided and well-dispersed particles within the thermoplastic medium, the rubber particles may have an average diameter that is less than 50 μm, such as less than 30 μm, such as less than 10 μm, such as less than 5 μm, such as less than 1 μm. In preferred embodiments, at least 50%, such as at least 60%, such as at least 75% of the rubber particles may have an average diameter of less than 5 μm, such as less than 2 μm, such as less than 1 μm.

The degree of cure can be measured by determining the amount of rubber that is extractable from the thermoplastic vulcanizate by using cyclohexane or boiling xylene as an extractant. Preferably, the rubber may have a degree of cure where not more than 15 weight percent, such as not more than 10 weight percent, such as not more than 5 weight percent, such as not more than 3 weight percent is extractable by cyclohexane at 23° C. as described in U.S. Pat. Nos. 4,311,628, 5,100,947 and 5,157,081, all of which are incorporated herein by reference. Alternatively, the rubber may have a degree of cure such that the crosslink density is at least 4×10⁻⁵, such as at least 7×10⁻⁵, such as at least 10×10⁻⁵ moles per milliliter of rubber. See Crosslink Densities and Phase Morphologies in Dynamically Vulcanized TPEs, by Ellul et al., Rubber Chemistry and Technology, Vol. 68, pp. 573-584 (1995).

The resulting thermoplastic vulcanizate may have the desired density that allows it to be utilized for a molded part as described herein. In this regard, the density may be 0.3 g/cm³ or more, such as 0.4 g/cm³ or more, such as 0.5 g/cm³ or more, such as 0.6 g/cm³ or more, such as 0.65 g/cm³ or more, such as 0.7 g/cm³ or more, such as 0.75 g/cm³ or more, such as 0.8 g/cm³ or more, such as 0.85 g/cm³ or more, such as 0.9 g/cm³ or more, such as 0.95 g/cm³ or more, such as 1 g/cm³ or more, such as 1.05 g/cm³ or more, such as 1.1 g/cm³ or more, such as 1.15 g/cm³ or more, such as 1.2 g/cm³ or more. The density may be 2 g/cm³ or less, such as 1.8 g/cm³ or less, such as 1.6 g/cm³ or less, such as 1.4 g/cm³ or less, such as 1.3 g/cm³ or less, such as 1.2 g/cm³ or less, such as 1.1 g/cm³ or less, such as 1.0 g/cm³ or less, such as 0.95 g/cm³ or less, such 0.90 g/cm³ or less, such as 0.7 g/cm³ or less, such as 0.6 g/cm³ or less, such as 0.55 g/cm³ or less.

### H. Molded Parts/Articles

Once formed, the thermoplastic vulcanizate may be shaped into the form of a molded part or article using any of a variety of techniques as is known in the art. For instance, the thermoplastic vulcanizate can advantageously be fabricated by employing typical molding processes, such as injection molding, extrusion molding, compression molding, blow molding, rotational molding, overmolding, etc. In general, these processes include heating the thermoplastic vulcanizate to a temperature that is equal to or in excess of the melt temperature of the thermoplastic copolyester elastomer to form a pre-form for a mold cavity to then form the molded part, cooling the molded part to a temperature at or below the crystallization temperature of the thermoplastic vulcanizate, and releasing the molded part/article from a mold. The mold cavity defines the shape of the molded part/article. The molded part/article is cooled within the mold at a temperature at or below the crystallization temperature of the thermoplastic vulcanizate and the molded part/article can subsequently be released from the mold. The process may also utilize extrusion molding. In this regard, the thermoplastic vulcanizate may be extruded as described herein. Upon exiting the extruder, the thermoplastic vulcanizate may be formed or shaped to a desired part/article. Such part/article may be formed by using a particular die to shape the thermoplastic vulcanizate as it exits the extruder. Such shaping/forming process, such as the extrusion process, may be an automated or robotic process.

The thermoplastic vulcanizate as disclosed herein may be utilized in a variety of applications. In particular, these applications may include those having relatively higher heat or temperature requirements. In addition, the applications may include those utilized in the outdoors.

The part/article may include those for the automotive industry, oilfield industry, consumer goods industry, electronics industry, electrical industry, medical industry etc. In particular, the part/article may be an automotive part.

Particular parts/articles may include, but are not limited to, seals, gaskets, ducts, belts, moldings, boots, hoses and the like articles. The parts/articles particularly for automotive applications may include, but are not limited to, weather seals, glass run channels, brake parts such as cups, coupling disks, and diaphragm cups, boots for constant velocity joints and rack and pinion joints, tubing, sealing gaskets, parts of hydraulically or pneumatically operated apparatus, o-rings, pistons, valves, valve seats, valve guides, and other elastomeric polymer based parts or elastomeric polymers combined with other materials such as metal/plastic combination materials. The parts/articles may also include transmission belts including V-belts, toothed belts with truncated ribs containing fabric faced V's, ground short fiber reinforced V's or molded gum with short fiber flocked V's.

The following test methods may be employed to determine the properties referenced herein.

### Test Methods

Melting Temperature, Glass Transition Temperature, Heat of Fusion: The melting temperature (“Tm”), glass transition temperature (“Tg”), and the heat of fusion (“Hf”) may be determined by differential scanning calorimetry (“DSC”) as is known in the art using commercially available equipment such as a TA Instruments Model Q100. Typically, 6 to 10 mg of the sample, that has been stored at room temperature (about 23° C.) for at least 48 hours, is sealed in an aluminum pan and loaded into the instrument at room temperature (about 23° C.). The sample is equilibrated at 25° C. and then it is cooled at a cooling rate of 10° C./min to −80° C. The sample is held at −80° C. for 5 min and then heated at a heating rate of 10° C./min to 25° C. The glass transition temperature is measured from this heating cycle (“first heat”). For samples displaying multiple peaks, the melting point (or melting temperature) is defined to be the peak melting temperature associated with the largest endothermic calorimetric response in that range of temperatures from the DSC melting trace. The T_{g} was measured by again heating the sample from −80° C. to 80° C. at a rate of 20° C./min (“second heat”). The glass transition temperature reported is the midpoint of step change when heated during the second heating cycle. Areas under the DSC curve are used to determine the heat of transition (heat of fusion, Hf, upon melting or heat of crystallization, Hc, upon crystallization, if the Hf value from the melting is different from the Hc value obtained for the heat of crystallization, then the value from the melting (Tm) shall be used), which can be used to calculate the degree of crystallinity (also called the percent crystallinity). The percent crystallinity (X %) is calculated using the formula: [area under the curve (in J/g)/H° (in J/g)]*100, where H° is the heat of fusion for the homopolymer of the major monomer component. These values for H° are to be obtained from the Polymer Handbook, Fourth Edition, published by John Wiley and Sons, New York 1999, except that a value of 290 J/g is used as the equilibrium heat of fusion (H°) for 100% crystalline polyethylene, a value of 140 J/g is used as the equilibrium heat of fusion (H°) for 100% crystalline polybutene, and a value of 207 J/g (H°) is used as the heat of fusion for a 100% crystalline polypropylene.

### EXAMPLES

### Example 1

The components identified in the table provided below were melt blended and dynamically cured to provide a thermoplastic vulcanizate including an at least partially cured EPDM. The thermoplastic copolyester elastomer included a polybutylene terephthalate hard block and a polycarbonate soft block. The curing was conducted in a twin-screw extruder at 220-250° C. and pelletized.

| | Ex. 1 | Ex. 2 |
|---|---|---|
| Component | (phr) | (phr) |
| Thermoplastic copolyester elastomer | 200 | 150 |
| Kaolin clay | 12 | 12 |
| Ethylene/glycidyl methacrylate copolymer | 30 | 30 |
| EPDM (including oil extension 100 phr) | 200 | 200 |
| Silicon-hydride functional polysiloxane | 3 | 3 |
| Platinum slurry (including 20 phr oil) | 21.5 | 21.5 |
| Total | 466.5 | 416.5 |

In addition, comparative samples were prepared as provided in the table below.

| | Comp. | Comp. |
|---|---|---|
| | Ex. 1 | Ex. 2 |
| Component | (wt. %) | (wt. %) |
| EPDM (including oil extension 75 phr) | 49.8 | 46.2 |
| Polypropylene | 17.1 | 23.0 |
| Paraffin oil | 13.9 | 13.0 |
| Kaolin Clay | 12.0 | 11.1 |
| Phenolic resin in oil | 3.9 | 3.4 |
| Tin chloride (masterbatch in polypropylene) | 0.5 | 0.4 |
| Zinc Oxide | 0.4 | 0.4 |
| Carbon black (masterbatch in polypropylene) | 2.4 | 2.5 |
| Total | 100.0 | 100.0 |

The samples were prepared into 2 mm plaques using injection molding at 190-230° C. and then tested. The results are provided in the table below:

| | Comp. Ex. | | Comp. Ex. | |
|---|---|---|---|---|
| Properties | 1 | Ex. 1 | 2 | Ex. 2 |
| Density (g/cm³) | 0.9667 | 1.004 | 0.9613 | 1.024 |

Original

| | | | | |
|---|---|---|---|---|
| Hardness (Shore A) | 77.3 | 75.1 | 85.3 | 80.7 |
| 100% modulus (MPa) | 3.92 | 3.59 | 5.09 | 4.52 |
| Tensile strength (MPa) | 8.12 | 5.45 | 10.14 | 6.49 |
| Elongation at break (%) | 449 | 294 | 557 | 298 |
| Tension set (%) | 24.5 | 36.0 | 31.0 | 37.5 |
| (70° C./22 hrs./50%) | | | | |

Air aged at 125° C. for 3 days

| | | | | |
|---|---|---|---|---|
| Hardness (Shore A) | 78.4 | 77.5 | 85.1 | 83 |
| 100% modulus (MPa) | 4.28 | 4.2 | 5.55 | 5.25 |
| Tensile strength (MPa) | 7.73 | 7.25 | 10.18 | 8.15 |
| Elongation at break (%) | 384 | 331 | 489 | 347 |

Air aged at 160° C. for 3 days

| | | | | |
|---|---|---|---|---|
| Hardness (Shore A) | sample | 79.4 | sample | 84.4 |
| 100% modulus (MPa) | deformed | 4.49 | deformed | 5.54 |
| Tensile strength (MPa) | in aging | 8.16 | in aging | 8.13 |
| Elongation at break (%) | oven | 304 | oven | 281 |

Oil aging in IRM 903

| | | | | |
|---|---|---|---|---|
| Weight gain (%) | 51.79 | 29.82 | 41.29 | 16.28 |
| 121° C. for 24 hrs. | | | | |

As indicated in the table below, the inventive examples demonstrated comparable and/or improved results compared to the comparative examples. For instance, the hardness of inventive example 1 was comparable to comparative example 1. In addition, while the tensile strength of inventive example 1 was lower than comparative example 1 initially, it was comparable after aging at 125° C. for 3 days. Also, the comparative examples were deformed after aging at 160° C. for 3 days while the inventive examples maintained structural integrity and exhibited desired results particularly when compared to the original results.

Also, to determine oil resistance performance, the samples were aged in IRM 903 oil at 121° C. for 24 hours and the weight gain properties were measured. According to the study, inventive examples 1 and 2 exhibited a lower weight gain compared to the comparative examples thereby indicating a better oil resistance performance.

Also, atomic force microscopy was conducted on the inventive samples. The images indicated excellent compatibility of inventive examples 1 and 2.

### Example 2

The components identified in the table provided below were melt blended and dynamically cured to provide a thermoplastic vulcanizate including an at least partially cured EPDM. The thermoplastic copolyester elastomer included a polybutylene terephthalate hard block and a polytetramethyleneoxide soft block. The curing was conducted in a Brabender mixer at 220° C.

| | Ex. 3 | Ex. 4 |
|---|---|---|
| Component | (phr) | (phr) |
| Thermoplastic copolyester elastomer | 70 | 50 |
| Carboxylated butadiene/acrylonitrile rubber | 100 | 100 |
| Triisononyl trimellitate | 30 | 30 |
| Kaolin clay | 10 | 10 |
| Zinc oxide | 5 | 5 |
| Magnesium oxide | 2 | 2 |
| Aromatic amine antioxidant | 3.5 | 3.5 |
| Total | 220.5 | 200.5 |

The samples were prepared into 2 mm plaques using injection molding at 190-230° C. and then tested. The results are provided in the table below:

| Properties | Ex. 3 | Ex. 4 |
|---|---|---|
| Density (g/cm³) | 1.0834 | 1.0812 |

Original

| | | |
|---|---|---|
| Hardness (Shore A) | 65.1 | 60.72 |
| 100% modulus (MPa) | 3.41 | 3.48 |
| Tensile strength (MPa) | 10.85 | 8.34 |
| Elongation at break (%) | 503.1 | 358 |

Oil aging in IRM 903

| | | |
|---|---|---|
| Weight gain (%) | 4.020 | 3.011 |
| (121° C. for 24 hrs) | | |

As indicated in the table below, the inventive examples demonstrated desired hardness and mechanical properties as well as oil resistance performance.

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A thermoplastic vulcanizate comprising:
a thermoplastic copolyester elastomer in an amount of about 5 wt. % or more to about 50 wt. % or less based on the weight of the thermoplastic vulcanizate;
an at least partially cured elastomer in an amount of about 5 wt. % or more to about 90 wt. % or less based on the weight of the thermoplastic vulcanizate, wherein the weight ratio of the at least partially cured elastomer to the thermoplastic copolyester elastomer is less than 1.25; and
a compatibilizer in an amount of from 1 wt. % or more to about 30 wt. % or less;
wherein the thermoplastic vulcanizate has an elongation at break of 200% or more.

2. The thermoplastic vulcanizate of claim 1, wherein the thermoplastic copolyester elastomer is a thermoplastic copolyestercarbonate elastomer, a thermoplastic copolyetherester elastomer, or a mixture thereof.

3. The thermoplastic vulcanizate of claim 1, wherein the thermoplastic copolyester elastomer contains a hard segment derived from at least one aromatic dicarboxylic acid and/or a diester thereof and at least one diol containing from 2 to 15 carbon atoms.

4. The thermoplastic vulcanizate of claim 3, wherein the aromatic dicarboxylic acid includes terephthalic acid, isophthalic acid, or a combination thereof and wherein the diol includes ethylene glycol, 1,4 butanediol, 1,3-propane diol, or a combination thereof.

5. The thermoplastic vulcanizate of claim 1, wherein the thermoplastic copolyester elastomer contains a soft segment derived from at least one aromatic dicarboxylic acid and/or a diester thereof and at least one poly(alkylene oxide) glycol.

6. The thermoplastic vulcanizate of claim 5, wherein the aromatic dicarboxylic acid includes terephthalic acid, isophthalic acid, or a combination thereof and wherein the poly(alkylene oxide) glycol includes poly(tetramethylene oxide) glycol, poly(trimethylene oxide) glycol, poly(propylene oxide) glycol, poly(ethylene oxide) glycol, poly(hexamethylene oxide) glycol, or a combination thereof.

7. The thermoplastic vulcanizate of claim 1, wherein the thermoplastic copolyester elastomer contains a hard segment and a soft segment, wherein the hard segment comprises polybutylene terephthalate and wherein the soft segment comprises polytetramethylene oxide, polycarbonate, or a combination thereof.

8. The thermoplastic vulcanizate of claim 1, wherein the at least partially cured elastomer comprises a polyolefin elastomer copolymer, natural rubber, styrene-butadiene copolymer rubber, butadiene rubber, acrylonitrile rubber, halogenated rubber, butadiene-styrene-vinyl pyridine rubber, urethane rubber, polyisoprene rubber, epichlolorohydrin terpolymer rubber, polychloroprene, or a mixture thereof.

9. The thermoplastic vulcanizate of claim 1, wherein the at least partially cured elastomer comprises an ethylene/propylene/non-conjugated diene copolymer rubber (EPDM).

10. The thermoplastic vulcanizate of claim 1, wherein the compatibilizer comprises a functionalized polyolefin including a functional group comprising a carboxy group or an ester thereof, a carbonyl group, a halogen atom, an amino group, a hydroxy group, an anhydride group, an epoxy group, or an oxazoline group.

11. The thermoplastic vulcanizate of claim 1, wherein the compatibilizer comprises an olefin copolymer comprising an olefinic monomeric unit and an epoxy-functional monomeric unit.

12. The thermoplastic vulcanizate of claim 11, wherein the olefin copolymer further comprises a non-epoxy functional monomeric unit comprising a meth(acrylic) monomeric unit.

13. The thermoplastic vulcanizate of claim 1, wherein the compatibilizer comprises an olefin copolymer comprising a graft polymer.

14. The thermoplastic vulcanizate of claim 13, wherein the graft polymer comprises at least one vinyl polymer.

15. The thermoplastic vulcanizate of claim 13, wherein the graft polymer comprises polyacrylonitrile, polystyrene, styrene/acrylonitrile copolymer, or polymethyl methacrylate.

16. The thermoplastic vulcanizate of claim 1, wherein the thermoplastic vulcanizate comprises from about 20 wt. % or more to about 50 wt. % or less of the thermoplastic copolyester elastomer, from about 10 wt. % or more to about 40 wt. % or less of the at least partially cured elastomer, and from about 1 wt. % or more to about 15 wt. % or less of the compatibilizer wherein the wt. % is based on the weight of the thermoplastic vulcanizate.

17. The thermoplastic vulcanizate of claim 1, wherein the thermoplastic vulcanizate exhibits a Shore A hardness of from 50 to 100 as determined in accordance with ISO 868-85 (15 seconds; unaged), a 100% modulus of from 0.3 MPa to 10 MPa as determined in accordance with ASTM D412-16 (unaged), a tensile strength of from 0.5 MPa to 10 MPa as determined in accordance with ASTM D412-16 (unaged), and/or an elongation at break of from 200% to 1500% as determined in accordance with ASTM D412-16 (unaged).

18. The thermoplastic vulcanizate of claim 17, wherein the Shore A hardness, 100% modulus, tensile strength, and/or elongation at break are exhibited after aging at 125° C. for 3 days and/or wherein the Shore A hardness, 100% modulus, tensile strength, and/or elongation at break are exhibited after aging at 160° C. for 3 days.

19. An automotive article comprising the thermoplastic vulcanizate of claim 1.

20. The article of claim 19, wherein the article comprises a seal, a gasket, a duct, a belt, a boot, or a hose.
